(19) United States
(12) Patent Application Publication
(10) Pub. No.: US 2017/0026401 A1
(43) Pub. Date: Jan. 26, 2017

(54) SYSTEM AND METHOD FOR THREAT VISUALIZATION AND RISK CORRELATION OF CONNECTED SOFTWARE APPLICATIONS

(71) Applicant: ERPScan B.V., Amsterdam (NL)

(72) Inventor: Alexander Polyakov, Moscow (RU)

(21) Appl. No.: 15/217,129

(22) Filed: Jul. 22, 2016

Related U.S. Application Data
(60) Provisional application No. 62/196,384, filed on Jul. 24, 2015.

(51) Int. Cl. H04L 29/06

(52) U.S. Cl. CPC H04L 63/1433; H04L 63/20; H04L 63/101; H04L 63/1441

(57) ABSTRACT

A system and method for identifying security threats for software applications in a computing environment and correlating risks of the security threats. An exemplary method includes collecting security issues of target systems in the computing environment, identifying connections of each target system with connection indicating the target system's ability to access an additional system in the computing environment by a software applications, determining a connection weight for each identified connection that indicates the target system's ability to access the additional system using the identified connection, prioritizing the security threats based on the security issues of each target system and the connection weights for each identified connection, and selecting remediation actions based on the prioritization of the security threats.

### CROSS REFERENCE TO RELATED APPLICATIONS

The present application claims priority to U.S. Provisional Patent Application Ser. No. 62/196,384, filed Jul. 24, 2015, the entire contents of which are incorporated herein by reference.

### FIELD OF TECHNOLOGY

The present disclosure generally relates to the field of computer security, and, more specifically, to a system and method for threat visualization and risk correlation of connected software applications in a distributed system.

### BACKGROUND

Enterprise business applications are “big” business application, such as ERP (“Enterprise Resource Planning”), SRM (“Supplier Relationship Management”), PLM (“Product Lifecycle Management”), and the like, are very complex and extremely customizable systems. In today's corporate environment, enterprise applications are complex, scalable, distributed, component-based, and mission-critical, and can be deployed on a variety of platforms across corporate networks, intranets, or the Internet. For example, only in SAP® there are over 7000 different configuration options and 3500 vulnerabilities that can affect system security. Moreover, there are different modules and industry solutions with specific configurations and vulnerabilities installed additionally. These applications are actually custom programs written in a specific language, such as ABAP for SAP systems, PeopleCode for Oracle® systems, and X++ Microsoft Dynamics®, for example.

In general, enterprise application software (“EAS”) is purpose-designed computer software used to satisfy the needs of an organization rather than individual users. Services provided by enterprise software are typically business-oriented tools such as online shopping and online payment processing, interactive product catalogue, automated billing systems, security, enterprise content management, IT service management, customer relationship management, enterprise resource planning, business intelligence, project management, collaboration, human resource management, manufacturing, enterprise application integration, and enterprise forms automation.

Given the number of applications, computer systems, databases, and other components involved in this environment, it is easy to realize that security of the systems and the data is a critical aspect to any business's implementation of enterprise application software. When considering such security issues, there are generally three different areas that need to be considered.

The first area is application security. This area includes all issues that can be found in a default installation of a business application. These include configuration issues, such as password policy, unnecessary enabled functionality, encryption, and other configuration options that can affect security of the application. Application security also includes program vulnerabilities identified in application components and detection of security-related events.

The second area is custom code security. In general, business applications provide a very broad spectrum of customization options, for example, businesses can develop their own specific modules by using specific languages (e.g., either DSL-languages or even typical ones). However, programs written on these languages may have vulnerabilities that can, for example, allow a malicious user to gain access to an application and/or data. In addition, these programs may also have “backdoors” left by developers.

The third area relates to access governance, i.e., to user access control. In general, enterprise applications have a very complex role model system. It is critical that none of the users can execute functions they are not authorized to do. For example, business applications should minimize the number of users with administrator rights. Moreover, in terms of segregation of duties, there should be no users with access to two or more functions that provide an opportunity to execute a fraudulent action in the system. For example, one user should not have access to functionality that allows him/her to create a payment order and then approve it.

When dealing with these wide scale and complex software applications, one of the major problems dealing with security issues is to build a process to prioritize all the security problems and vulnerabilities in a large scale.

### SUMMARY

Accordingly, what is needed is a system that can minimize the number of false positives, correlate risks depending on how different vulnerabilities affect each other's criticality, understand how vulnerabilities in one application affect security of another application, detect the most important attack vectors that can be performed by identified vulnerabilities, and prioritize remediation actions by analyzing which applications affect the security of the whole infrastructure more so than others do.

As described above, business applications such as ERP systems are highly interconnected. For example, ERP system based on SAP NetWeaver ABAP platform can be connected with Enterprise Portal based on SAP NetWeaver J2EE platform. In this instance, a vulnerability in Enterprise Portal, usually available, via the Internet can affect ERP platform, which, as a rule, is located inside the secured network perimeter.

As described herein, the system and method provide a threat modeling for such security issues where the main methodology is to help customers save time on the analysis and understand the most critical vulnerabilities affecting an organization. The threat modeling indicates whether it is possible to gain unauthorized access from one application to another as it goes during penetration testing or a hacker attack. As the system and method determines that there is a way to access one application from another, the system and method measures its likelihood degree, depending on different factors.

In general, the system and method disclosed here collects information about application vulnerabilities, security-related events, or any other security-related problems using its own methods and/or from other vulnerability scanners, source code scanners, segregation of duties tools, event management tools, network traffic management tools, and other security solutions. Moreover, the system and method collects information about different connections between applications and also collects information about different methods of getting access from one application to another (i.e., “potential” connections). The system then correlates obtained information to calculate risks of different vulnerabilities based on information about other vulnerabilities and prioritizes remediation actions for applications based on applications severity, application issues and previously collected information such as attack paths.

According to one aspect, a method is provided for identifying security threats for software applications in a computing environment and correlating risks of the security threats. In this aspect, the method includes collecting, by a computer processor, information relating to security issues in target systems of the computing environment, the security issues relating to at least one of vulnerabilities of one or more of the software applications being executed on the target systems and one or more security related events occurring on the target systems; identifying connections of each target system in the computing environment, wherein each connection is between the target system an additional system in the computing environment that enables the target system to access the additional system; determining a connection weight for each identified connection, the connection weight indicating an ability of the respective target systems to access the additional system using the identified connection; prioritizing the security threats based on the information relating to the security issues of each target system and the connection weights for each identified connection of each target system; and performing at least one remediation action for at least one security threat based on the prioritizing of the security threats.

According to another aspect, the identifying of connections comprises identifying a technical connection between the target system and the additional system by at least one of a connection interface and an API.

According to another aspect, the identifying of connections comprises analyzing configurations of the target system that enable access to the additional system in the computing environment by at least one of the software applications.

According to another aspect, the method includes collecting information associated with the existing connection including at least one of an source system identificator (such as SID or domain name or any other ID), a host source address (such as IP or MAC address), a destination system identificator (such as SID or domain name or any other id), a host destination address such as IP or MAC adress, a connection type, and connection settings; and determining the connection weight for the existing connection based on the collected information.

According to another aspect, the analyzing of configurations of the target system include identifying passwords, password hashes, keys, SSO tokens and any other authentication mechanisms for the target system and determining whether the identified passwords enable the access to the additional system in the computing environment.

According to another aspect, the prioritizing of the security threats comprises calculating a remediation priority index for each target system in the computing environment. Furthermore, in one aspect, the method includes performing at least one remediation action comprises performing the remediation action for the target system with the highest remediation priority index.

According to another aspect, the calculating of the remediation priority index is based on system health of the target system, severity of the target system, severity of the additional system, and a maximum value of path weights, wherein each path weight is a product of each connection weight for each direction connection between the target system and the additional system.

According to another aspect, the collecting of the information relating to security issues includes collecting default credentials of the software applications for a list and number of users with default credentials, a list and number of application vulnerabilities, application misconfigurations that enable a hacker to penetrate the target system, a list and number of missing security patches for the software applications, custom source code issues, a list and number of issues in access control of the software applications, and a list and number of security-related events.

According to one aspect, a system is provided for identifying security threats for software applications in a computing environment and correlating risks of the security threats. In this aspect, the system includes comprising a database comprising a plurality of connection weights associated with a plurality of types of connections between two or more systems in the computing environment; and a computer processor configured to collect information relating to security issues in target systems of the computing environment, the security issues relating to at least one of vulnerabilities of one or more of the software applications being executed on the target systems and one or more security related events occurring on the target systems, identify connections of each target system in the computing environment, wherein each connection is between the target system an additional system in the computing environment that enables the target system to access the additional system, determine a connection weight for each identified connection, the connection weight indicating an ability of the respective target systems to access the additional system using the identified connection, prioritize the security threats based on the information relating to the security issues of each target system and the connection weights for each identified connection of each target system, and perform at least one remediation action for at least one security threat based on the prioritizing of the security threats.

According to another aspect, a non-transitory computer readable medium storing computer executable instructions is provided for identifying security threats for software applications in a computing environment and correlating risks of the security threats. In this aspect, instructions are included for collecting information relating to security issues in target systems of the computing environment, the security issues relating to at least one of vulnerabilities of one or more of the software applications being executed on the target systems and one or more security related events occurring on the target systems; identifying connections of each target system in the computing environment, wherein each connection is between the target system an additional system in the computing environment and the connection enables the target system to access the additional system; determining a connection weight for each identified connection, the connection weight indicating an ability of the respective target systems to access the additional system using the identified connection; prioritizing the security threats based on the information relating to the security issues of each target system and the connection weights for each identified connection of each target system; and performing at least one remediation action for at least one security threat based on the prioritizing of the security threats.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplary pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for threat visualization and risk correlation of connected software applications according to an exemplary aspect.

FIG. 2 illustrates a block diagram of a computer for threat visualization and risk correlation of connected software applications according to an exemplary aspect.

FIG. 3 illustrates a visual depiction of an exemplary distributed system with multiple paths according to an exemplary aspect.

FIGS. 4A and 4B illustrate a flowchart for a method for threat visualization and risk correlation of connected software applications according to an exemplary aspect.

FIG. 5 illustrates a screen shot of a user interface of the graphical representation illustrating a mapping of the systems in the computing environment and their connections according to an exemplary aspect.

FIG. 6 illustrates a screen shot of a user interface of the graphical representation for filtering settings according to an exemplary aspect.

FIG. 7 illustrates an example of a general-purpose computer system on which the disclosed systems and method can be implemented.

### DETAILED DESCRIPTION

Various aspects of the invention are now described with reference to the drawings, wherein like reference numerals are used to refer to like elements throughout. In the following description, for purposes of explanation, numerous specific details are set forth in order to promote a thorough understanding of one or more aspects of the invention. It may be evident in some or all instances, however, that any aspects described below can be practiced without adopting the specific design details described below. In other instances, well-known structures and devices are shown in block diagram form in order to facilitate description of one or more aspects. The following presents a simplified summary of one or more aspects of the invention in order to provide a basic understanding thereof.

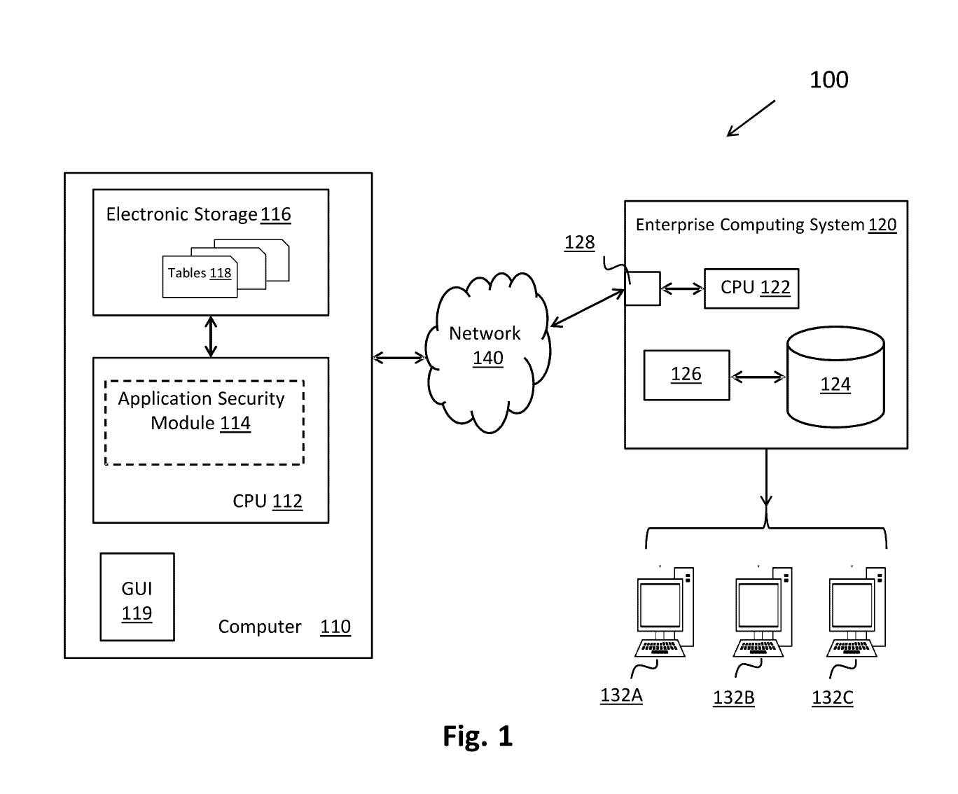

FIG. 1 is a block diagram illustrating a system for threat visualization and risk correlation of connected software applications according to an exemplary aspect. As shown, the applications can be part of a distributed system, such as a system implemented an enterprise application software environment for a complex business solution, for example. In general the system 100 includes a host computing system/computer 110 configured to analyse security issues (e.g., vulnerabilities) in a distributed system having a plurality of computer systems executing many software applications connected to each other during operation.

As illustrated, the computing system 110 is communicatively coupled to an enterprise computing system 120 through a network 140. In alternative embodiments, however, one or more of these components may not be part of the distributed computing system without departing from the scope of the present disclosure. For example, in some embodiments, the computing system 110 may not be included in the system 100, and logic (e.g., software modules, middleware, source code, executable instructions, data, and otherwise, as described below) illustrated as residing on the computing system 110 may be located on, for example, the enterprise computing system 120 or another computing system communicably coupled through the network 140. In any event, the illustrated system 100 may have alternative embodiments where various components (e.g., servers, databases, software modules, and otherwise) are not present or reside in or on different appliances than shown in FIG. 1.

Each of the computing system 110 and enterprise computing system 120 includes a server appliance having a processor and an interface. As illustrated host computing system 110 includes a computer processing unit (“CPU”) 112. Moreover, the illustrated enterprise computing system 120 includes a processor (or processors) 122 and an interface (or interfaces) 128. In general, the computing system 110 and enterprise computing system 120 may each be one or more servers that store applications, software, middleware, and data, for example, any hosted applications located on in application database 124 of enterprise computing system 120.

In general, the computing system 110 and enterprise computing system 120 each represents an electronic computing device operable to receive, transmit, process, store, or manage data and information associated with the system 100. For example, the enterprise computing system 120 may be responsible for receiving application requests from one or more client applications associated with enterprise clients 132A, 132B and 132C and responding to the received requests by processing said requests in the application server 126, and sending the appropriate response back to the requesting enterprise clients 132A, 132B and 132C.

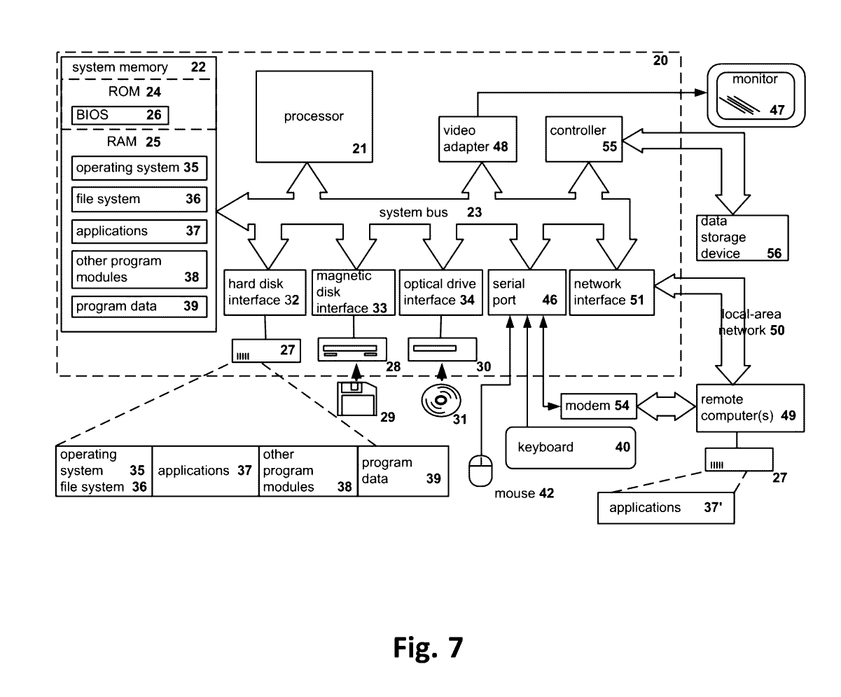

According to the exemplary aspect, the computing system 110 may be any type of computing device and preferably a separate server configured to manage the security of the distributed system, but alternatively can be a laptop, a desktop, and the like. The specific details of the exemplary computing system 110 will be described below with respect to FIG. 7. However, as generally shown in FIG. 1, the computer 110 includes the CPU 112, an application security module 114 and electronic storage, i.e., memory 116, which stores tables 118 among other data. According to an exemplary aspect, the electronic storage 116 can be a computer-readable medium includes data storage, and, by way of example, and not limitation, can comprise RAM, ROM, EEPROM, CD-ROM, Flash memory or other types of electric, magnetic, or optical storage medium, or any other medium.

It should be appreciated that while the exemplary aspect is described as being implemented on single computer 110, the system and method can also be implemented on multiple computers according to an alternative aspect. Thus, for the purpose of high availability, the system can include several computers with such services deployed and services have some consensus protocol to communicate and agree on each other action.

According to one aspect, the application security module 114 includes software code (e.g., processor executable instructions) in memory, which may be configured to execute/facilitate the algorithms described herein for the threat visualization and risk correlation of connected software applications and target systems in system 100. For example, the target systems can be enterprise clients 132A, 132B and 132C according to an exemplary aspect. Moreover, although FIG. 1 illustrates only three enterprise clients 132A, 132B and 132C, it is contemplated that the distributed system can include numerous computing systems have one or multiple applications executed thereon during operation of enterprise application software environment, for example. As will be explained in detail below, the computing system 110 is configured to evaluate the connections between the systems and/or applications, identify vulnerabilities in the system, prioritize the remediation of such vulnerabilities, and execute remediation actions accordingly.

It is reiterated that the distributed system illustrated in FIG. 1, including the enterprise computing system and enterprise clients 132A, 132B and 132C, is provided solely for illustrative purposes and much more complex systems with very intricate connections can be evaluated according to the exemplary system and method described herein. As further shown, computer 110 can include a graphical user interface 119 configured to display reports of the threat visualization as will be discussed in detail below.

As further noted above, the computing system 110 is capable of communicating with the enterprise computing system 120 via network 140. Network 140 can be any network for communicating data and data operations and can include a communication system (not shown) that connects the various computers of the system by wire, cable, fiber optic, and/or wireless links facilitated by various types of well-known network elements, such as hubs, switches, routers, and the like. Network 140 may employ various well-known protocols to communicate information amongst the network resources. In one aspect, the network 140 can be part of the Internet or intranet using various communications infrastructure such as Ethernet, WiFi and the like.

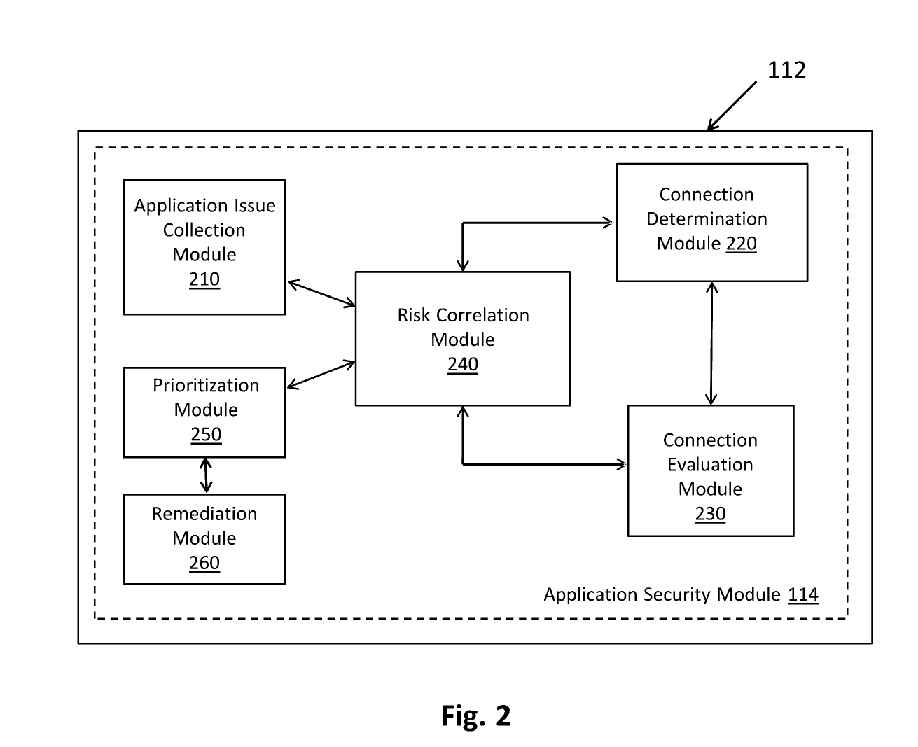

FIG. 2 illustrates a block diagram of a computer for threat visualization and risk correlation of connected software applications according to an exemplary aspect. In particular, the client computer shown in FIG. 2 illustrates a more detailed view of the CPU 112 of the computing system 110 of system 100 described above with respect to FIG. 1.

As described above, the computing system 110 includes a CPU 112 and an application security module 114 that is configured to perform the algorithms described below for threat visualization and risk correlation of connected software applications according to the exemplary aspects. As shown in FIG. 2, the application security module 114 can be composed of a plurality of modules. In particular, the application security module 114 can include an application issue collection module 210, a connection determination module 220, a connection evaluation module 230, a risk correlation module 240, a prioritization module 250, and a remediation module 260. The specific algorithms performed by each module will be discussed in detail below. However, in general, as used herein, the term “module” refers to a software service or application executed on one or more computers, including real-world devices, components, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general purpose computer. Accordingly, each module can be realized in a variety of suitable configurations, and should not be limited to any example implementation exemplified herein.

According to an exemplary aspect, the application issue collection module 210 is configured to collect information about vulnerabilities of the applications in the target systems, security-related events, or any other security-related problems/issues. According to an exemplary aspect, the application issue collection module 210 can collect this information from the applications in the systems using customized tools and/or third party software, such as vulnerability scanners, source code scanners, segregation of duties tools, event management tools, network traffic management tools, and the like.

In more particularity, the information collected can include default credentials of the applications that provide a list and number of application users with default credentials, i.e., the list of users can be used to perform attacks. Moreover, the information can include a list and number of application vulnerabilities that can be used to perform attacks on the system and gain unauthorized access to the application and/or system data. Furthermore, configuration issues can be identified that include misconfigurations that can be used by a fraudster or hacker (i.e., cybercriminals), for example, to penetrate the system. The information can further include a list and number of missing security patches for various applications, custom source code issues that include vulnerabilities in the custom code, a list and number of issues in access control, and, finally, a list and number of security-related events.

According to the exemplary aspect, once this information is collected from the system by application issue collection module 210, the information can be stored in electronic storage 116 of computer 110. It should be appreciated that the number of issues identified can be in the thousands or even greater depending on the size of the enterprise application. Accordingly, computer 110 cannot simply address them in a chronological order, but must rather prioritize the remediation actions of these identified issues as will be discussed in detail below.

As described above, the systems implementing the complex business environment can be comprises of a number of systems and applications that can be connected to each other through a number for different software functions, for example. The connection determination module 220 is configured to identify the potential connections in the system and determine a connection weight variable based on the connection settings. In general, “potential” connections mean all methods that penetration testers or cybercriminals can use to pivot from one system/application to another. According to an exemplary aspect, the connection determination module 220 is configured to collect information about the methods from different sources and define weight's for each connection based on different factors such as user rights, a type of access, protocol type, connection algorithms and the like.

In one aspect, the weight value of each type of connection (i.e., the “connection weight”) is set by default and can be changed by a system administrator according to a high risk model, for example. The following Table 1 illustrates an exemplary aspect of weight values of potential connections identified in the distributed system. As shown, the weight values are between 0.0 and 1.0 according to the exemplary aspect.

TABLE 1

| Existing/Potential Connection | Connection Weight |
|---|---|
| RFC_ConnWeight_withPass | 0.8 |
| RFC_ConnWeight_withoutPas | 0.2 |
| DB_ConnWeight_HANA | 0.2 |
| DB_ConnWeight_ORCL_withUser_withEncr | 0.5 |
| DB_ConnWeight_ORCL_withUser | 0.6 |
| DB_ConnWeight_ORCL | 0.1 |
| MII_ConnWeight | 0.2 |
| MII_ConnWeight_withEncr | 0.15 |
| BOBJ_ConnWeight | 0.2 |
| BOBJDS_ConnWeight_withUser | 0.4 |
| BOBJDS_ConnWeight | 0.2 |
| PI_ConnWeight_withPass | 0.8 |
| PI_ConnWeight_withUser | 0.3 |
| PI_ConnWeight_withUser_withProxyPasss | 0.7 |
| PI_ConnWeight_withUser_withProxy | 0.2 |
| PI_ConnWeight_withUser_withProxy_withEncr | 0.15 |
| PI_ConnWeight_withUser_withEncr | 0.25 |
| PI_ConnWeight | 0.1 |
| ABAPRFC_ConnWeight_withPass | 0.8 |
| ABAPRFC_ConnWeight_withEncr | 0.25 |
| ABAPRFC_ConnWeight_withEncr_withProxy | 0.15 |
| ABAPRFC_ConnWeight_withProxy | 0.2 |
| ABAPRFC_ConnWeight_withUser | 0.3 |
| ABAPRFC_ConnWeight_null | 0.1 |
| J2EERFC_ConnWeight_withPass_withEncr | 0.5 |
| J2EERFC_ConnWeight_withPass | 0.8 |
| J2EERFC_ConnWeight_withUser | 0.4 |
| J2EERFC_ConnWeight_withUser_withEncr | 0.3 |
| J2EERFC_ConnWeight_withUser | 0.4 |
| J2EERFC_ConnWeight_null | 0.1 |
| ABAPDBCON_ConnWeight_withPass | 0.7 |
| ABAPDBCON_ConnWeight_withUser | 0.4 |
| ABAPDBCON_ConnWeight_null | 0.1 |
| BOBJF_ConnWeight_withUser | 0.4 |
| BOBJF_ConnWeight | 0.1 |
| SMP_ConnWeight_withPass | 0.8 |
| SMP_ConnWeight_withUser | 0.4 |
| SMP_ConnWeight_withUser_withEncr | 0.3 |
| SMP_ConnWeight_null | 0.1 |
| Potential_ConnWeight_Domain | 0.7 |
| Potential_ConnWeight_HostsEquiv | 0.9 |
| Potential_ConnWeight_CUA | 0.6 |
| Potential_ConnWeight_IAM | 0.2 |
| Potential_ConnWeight_keys | 0.6 |
| Potential_ConnWeight_ospass | 0.4 |
| Potential_ConnWeight_sso | 0.7 |
| Potential_ConnWeight_Apppass | 0.5 |

The exemplary connections and weights can be divided into a number of groups or categories. According to the exemplary aspect, the connection determination module 220 is configured to collect information about different system configurations that allow two systems to trust each other, which, would mean that an attacker who gets access to one system can easily get access to another system. In other words, the specific system/application configuration creates a “potential” connection between two or more systems/applications that trust each.

For example, in one aspect, the targeted system(s) can be configured such that two software applications can support Windows domain authentication and can be accessed under the same user role. Thus, according to an exemplary aspect, the connection determination module 220 is configured to gather information about supported authentication from these two or more different applications and, based on this information determine whether it is possible to get access from one application to another or not.

In this aspect, the connection determination module 220 is configured to execute an OS “whoami” command in an SAP application, for example, to obtain information about the domain name and user under which the SAP application is running if we have two SAP systems with the same domain name and user name. In this instance, the connection weight between the two software applications is “Potential_ConnWeight_Domain” and the connection type is “DOMAIN”, as shown above in Table 1. In general, it should be appreciated that the connection determination module 220 considers each connection and weight to have a “potential” threat type.

In another aspect, the distributed system can be configured such that two applications located on the system shown in FIG. 1, for example, can trust each other by protocols such as rsh/rlogin. In this aspect, the connection determination module 220 is configured to check /etc/hosts.equiv.if there is+string in which a single line of+in the “/etc/hosts.equiv” file indicates that every known host is trusted. If there is a string with a host name, the connection determination module 220 can add this host to the list of trusted hosts. In this aspect, the connection weight for this potential connection is “Potential_ConnWeight_HostEquiv” and the connection type is “RSH”, as shown in Table 1.

In another aspect, the targeted system(s) of FIG. 1 can be configured such that two applications, for example, can share users in SAP CUA (“central use administration”) and can be accessed under the same user role. In this aspect, the connection determination module 220 is configured to check if there are certain RFC (“remote function call”) connections of CUA type. In this aspect, the connection weight for this potential connection is “Potential_ConnWeight_CUA” and the connection type is “CUA”, as shown in Table 1.

In another aspect, the targeted system(s) of FIG. 1 can be configured such that two applications, for example, can share users in LDAP (“lightweight directory access protocol”) or other user storage and can be accessed under the same user role. In this aspect, the connection determination module 220 is configured to check if this application stores users in remote system such as LDAP or IAM (“identity and access management”). In this aspect, the connection weight for this potential connection is “Potential_ConnWeight_IAM” and the connection type is “IAM”, as shown in Table 1.

In another aspect, the targeted system(s) of FIG. 1 can be configured such that two applications, for example, may use SSO (“single sign-on”). In this aspect, the connection determination module 220 is configured to check if one or more of the application(s) share SSO access with other applications. In this aspect, the connection weight for this potential connection is “Potential_ConnWeight_SSO” and the connection type is “SSO”, as shown in Table 1.

According to another aspect, the connection determination module 220 is further configured to collect information relating to stored keys, passwords, password hashes, tokens or other credentials or authentication mechanisms that may facilitate access to one or more of the applications of the targeted system(s) illustrated in FIG. 1. According to an exemplary aspect, the connection determination module 220 is configured to search various locations where keys, passwords, password hashes, tokens or other credentials or authentication mechanisms or any other information, may be located and which can access or help get access to connected applications. In other words, an attacker who has access to one application can somehow get security keys or logins and passwords for access to another application.

In this aspect, the connection determination module 220 is configured to determine whether to determine whether the same .SSH (“secure shell”) keys are used for server access. In this aspect, the connection determination module 220 is configured to check if two servers in the system have the same SSH keys. In this aspect, the connection weight for this potential connection is “Potential_ConnWeight_keys” and the connection type is “SSH”, as shown in Table 1. Thus, according to this aspect, the connection determination module 220 can collect information from two different applications and based on this information determine whether it is possible to get access from one system to another or not.

In another aspect, the connection determination module 220 is configured to determine universal users under the OS level in the targeted system(s) of FIG. 1. In this aspect, the connection determination module 220 collects information about the OS users of the various systems shown in FIG. 1, and also collected information relating to their passwords to compare passwords or password hashes. If there are two different servers with similar OS usernames and passwords, there is a chance that attacker will decrypt passwords in one system and try to use them for another system. In this aspect, the connection determination module 220 is configured to check users and passwords at the OS layer for Linux systems in “/etc/shadow” file, for example. If the connection determination module 220 determines that there are two similar users with similar password hashes then the connection weight for this potential connection is determined to be “Potential_ConnWeight_OsPass” and the connection type is “OS”, as shown in Table 1.

According to yet another aspect, the connection determination module 220 is configured to determine universal users in two or more applications of the targeted system(s) as shown in FIG. 1, for example. In this aspect, the connection determination module 220 collects information about users and their passwords and compare passwords or password hashes. If there are two different applications with similar usernames and passwords, there is a high possibility that a cybercriminal/hacker will be able to decrypt passwords in one system and try to use them for another system.

In this aspect, for a universal SAP J2EE_Admin user, if the connection determination module 220 identifies password hashes stored in a UME_STRINGS.VAL table, for example, and if there are two similar users with similar password hashes, then the connection determination module 220 identifies the connection weight for this potential connection as “Potential_ConnWeight_AppPass” and the connection type as “J2EEPASS”.

In another aspect, for universal SAP ABAP users, if the connection determination module 220 identifies stored in USR02 Table in such tables as BCODE, OCOD1, OCOD2 OCOD3, OCOD4, OCOD5, PWDSALTHASH, PASSCODE, and if there are two similar users with similar password hashes, then the connection determination module 220 identifies the connection weight for this potential connection as “Potential_ConnWeight_AppPass” and the connection type is “ABAPPASS”

In another aspect, for universal SAP Afaria users, if the connection determination module 220 identifies that passwords are stored in dbo.Users table, and if there are two similar users with similar password hashes, then the connection determination module 220 identifies the connection weight for this potential connection as “Potential_ConnWeight_AppPass”, and the connection type as “AFARIAPASS”.

In another aspect, for universal SAP HANA DB users, if the connection determination module 220 identifies passwords are stored in secure storage, and if there are two similar users with similar password hashes, then the connection determination module 220 identifies the connection weight for this potential connection as “Potential_ConnWeight_AppPass” and the connection type as “HANAPASS”.

In another aspect, for universal SAP BOBJ users, if the connection determination module 220 identifies that passwords are stored in CI_SYSTEMOBJECTS table for 4.0 and higher, Field: SI_KIND—object type need ‘USER’, SI NAME —user name, SI_ID—user id (id Administrator user always 12), and if there are two similar users with similar password hashes, then the connection determination module 220 identifies the connection weight for this potential connection as “Potential_ConnWeight_AppPass” and the connection type as “BOBJPASS”.

In another aspect, for universal Oracle Peoplesoft users, if the connection determination module 220 identifies passwords are stored in PSOPRDEFN table—MS SQL and SYSADM.PSOPRDEFN table—in Oracle DB, Field: OPRID—User ID (User Name), OPERPSWDSALT—Password Hash Salt, OPERPSWD—Password Hash Value (SHA1), and if there are two similar users with similar password hashes, then the connection determination module 220 identifies the connection weight for this potential connection as “Potential_ConnWeight_AppPass” and the connection type is “PeoplesoftPASS”.

In another aspect, for universal Oracle EBS users, if the connection determination module 220 identifies passwords are stored in apps.fnd user table, with field:USER_NAME—User Name, ENCRYPTED_USER_PASSWORD—Encrypted password, and if there are two similar users with similar password hashes, then the connection determination module 220 identifies the connection weight for this potential connection as “Potential_ConnWeight_AppPass” and the connection type is “EBSPASS”.

In another aspect, for universal Oracle JDE users, if the connection determination module 220 identifies passwords are stored in F980WSEC table, for Field: SCUSER—User ID, SCOWPWD—EnterpriseOne Password, SCSECUSR—System User, SCSECPWD—System Password, and if there are two similar users with similar password hashes, then the connection determination module 220 identifies the connection weight for this potential connection as “Potential_ConnWeight_AppPass” and the connection type is “JDEPASS”.

In another aspect, for universal Oracle DB users, if the connection determination module 220 identifies passwords are stored in DBA_USERS table, for Field: USERNAME—Name of the user PASSWORD—Encrypted password, and if there are two similar users with similar password hashes, then the connection determination module 220 identifies the connection weight for this potential connection as “Potential_ConnWeight_AppPass” and the connection type as “OraclePASS”

Thus, according to the exemplary aspect, connection determination module 220 is configured to gather information about user passwords from each application, as well as other configuration information, and based on this information determine whether it is possible to get access from one application to another if there are two similar users with similar passwords in two different applications, for example.

According to an exemplary aspect, the connection determination module 220 collects information about all potential connections and associated connection weights from Table 1, according to the foregoing algorithms and stores this information in electronic storage 116 of computer 110, for example. After identifying these actual/potential connections, the system is further configured to collect information about the existing connections. In particular, for each specific application that is executed within the enterprise application of the system illustrated in FIG. 1, the computer 110 will have a list of all existing connections between this application and other applications. The computer 110 is further configured to provide special expertise to customers with multiple applications and prioritize issues, as all applications can be somehow connected, and issues in one application can affect security of other one and the whole system.

In general, there are many ways to get access from one application to another, depending on application type. For example, for RFC connections, in SAP, code can be executed in one system from another system or even login into one system through another by using RFC connections. These connections can store credentials to execute actions on a satellite system. In another aspect, two applications can be connected by using trust relations, which means that if you can login to one application you can login to another as well.

Thus, according to an exemplary aspect, the application security module 114 further includes a connection evaluation module 230 that is configured to collect information about different types of real/existing connections that connect two systems and/or applications, so that if an attacker gets access to one system, the attacker is basically inside another system. According to an exemplary aspect, the connection evaluation module 230 is configured to obtain information about the following possible existing connections:

SAP NetWeaver ABAP RFC Connections

SAP NetWeaver ABAP Database (DBCON) Connections

SAP NetWeaver ABAP SOA Connections

SAP NetWeaver J2EE RFC (for new versions)

SAP NetWeaver J2EE RFC (for old versions)

SAP BOBJ Services

SAP BOBJ DataServices

SAP BOBJ Federations

Oracle Database links

SAP HANA Database Links

SAP Mobile Platform Links

SAP PI Integration Builder

SAP XMII links

Moreover, other systems, such as SAP PlantConnect, Oracle Peoplesoft, Oracle EBS, Oracle JD, Microsoft Dynamic, Infor, Saleseforce, cloud applications, SCADA, MES, EMR and ICS and other industry solutions also have connections that can be analyzed in the similar way. The following descriptions provides exemplary algorithms as to the connection evaluation module 230 is configured to collect information about the foregoing different types of connections from each application.

According to one aspect, the connection evaluation module 230 is configured collect information about SAP NetWeaver ABAP RFC connections. In this aspect, the connection evaluation module 230 can collect data about source system identification (e.g., SID source), source host IP address, a destination system identification, a destination source IP address, connection type, connection settings and other values from a RFCDES table and based on those values, can determine a connection weight that will be used in the prioritization algorithm as discussed below.

In particular, for the RFCDES table description, the RFCDEST is the name of a connection. In this instance, the maximum length is 32 characters and any combination of characters is allowed. Moreover, the RFCTYPE is the type of a connection and has a maximum length of 1 character. The RFCDES can take the following values:

I—Connection to application server based on the same type of data system.

3—Connection to ABAP system.

2—Connection to r/2 system.

T—Invocation of external applications which use TCP/IP.

L—Reference values (references for other connections).

S—Launch of external applications via SNA or APPC.

X—RFC using special ABAP Driver Routines.

M—CMC connection.

H—HTTP connection to ABAP System.

G—Connection to external server.

null—Undefined type

Moreover, the connection evaluation module 230 can determine the RFCOPTIONS, which are the connection options and can have a maximum length of 250 characters. An example line is H=%%RFCSERVER%%,G=solman,g=sapgw00,Y=2,h=2,y=−2,z=−2,q=0,d=2, where H is an option, and %RFCSERVER% is a value of an option.

Moreover, the list of options include the following:

H=hostname/IP address

S=system number

M=client number

U=RFC user

L=language

X=load balancing (LB=ON)

I=system ID

N=logon group

Z=auth related

G=gateway host

g=gateway service

According to the exemplary aspect, the connection evaluation module 230 is configured to obtain the RFCDES table for the connection from one of the connecting applications and read it line by line. Moreover, according to the exemplary algorithms below, the connection evaluation module 230 is configured to fill in the following values of the final result: connection name, host source (IP or hostname), server type source, SID destination, host destination (IP or hostname), connection type, user, password, encryption, connection settings, client, threat, connection weight, and all other settings. These results can be stored as one or more of Tables 118 in memory 116 (see FIG. 1), according to an exemplary aspect.

According to an exemplary aspect, the connection evaluation module 230 sets the connection name as “RFCDEST”, the host source (IP or hostname) can be acquire from the scan engine, the server type source can be set as “ABAP”, and the SID destination can be I. Moreover, the connection evaluation module 230 can analyze the RFCOPTIONS field from the RFCDES table to obtain the host destination (IP or hostname).

The connection evaluation module 230 is configured to obtain the host destination in order to identify the H parameter (server address), which can be presented by different types of lines. If there is a “X=LB=ON” string in RFCOPTIONS value then the module 230 checks the last value /H/ and places it in host destination (IP or hostname) in the table, i.e., module 230 changes the value of host destination and puts the very line into connection settings, while removing the last H value. For example, If RFCOPTIONS=A=1,a=5,H=/H/147.204.2.5/S/sapdp99/H/oss001,S=01,M=001,U=OSS_RFC,L=E,v=%_PWD,X=LB=ON,I=O01,N=EWA, the host destination (IP or hostname) will be equal to oss001 and the connection settings will be equal to /H/147.204.2.5/S/sapdp99. Moreover, if there is a “g” or “G” string in RFCOPTIONS value then module 230 puts values into the connection settings—Gateway Host=G, Gateway Service=g. If there is only G in the field, then module 230 puts only G into the table. If there is neither G, nor g in the field, then module 230 puts nothing into the connection settings. Otherwise, there should be such kind of a line in the H parameter: /H/saprouter/S/3299/W/pass/H/targetserve.

In this aspect, the syntax for substrings: /H/ indicates the host name /S/ is used to specify the service (port); it is an optional entry, the default value is 3299; /W/ indicates the password for the connection between the predecessor and successor on the route and is also optional (default is “no password”). The host name /H/ is critical as module 230 is configured to put it into the host destination (IP or hostname) field, i.e., the module 230 is configured to change the value of host destination, and put the line (/H/saprouter/W/pass/H/targetserver) into the connection settings—H. For example, if RFCOPTIONS=/H/203.13.155.17/S/3299/W/tP41s/H/192.168.62.200, the host destination (IP or hostname) is set to 192.168.62.200, and the connection settings is set to SAProuter=/H/203.13.155.17/S/3299/W/tP41s/H/ 192.168.62.200.

In addition to the host name and connection settings, the connection evaluation module 230 is further configured to determine the connection type by analyzing RFCTYPE contents (the first line is an exception). If a connection name includes workflow_local_NNN, with NNN as a value, this connection belongs to SAP PI BPM type, and the module 230 writes SAP PI BPM in the field connection type. According to the exemplary aspect, if the value is set to 2, module 230 writes R/2 Connection, if the value is set to 3, module 230 writes the ABAP Connection, if the value is set to G, module 230 writes HTTP (external), if the value is set to L, module 230 writes CMC connection, if the value is set to T, module 230 writes TCP/IP, if the value is set to X, module 230 writes ABAP driver, if the value is set to I, module 230 writes internal connection, and if the value is set to null, module 230 writes undefined type.

Furthermore, the connection evaluation module 230 is configured to determine the user name by evaluating the RFCDES.RFCOPTIONS to identify the U parameter, where U is a user name. If there is one user name, module 230 extract its (user name only). In addition, the password is identified by evaluating the RFCDES.RFCOPTIONS. In this instance, the module 230 attempts to identify the V parameter (i.e., user's password), and if there is one there, module extracts Y, whereas if there is no parameter or it is set to null, module 230 extract N. Typically, a user's password has the following form: v=%_PWD.

In addition, the connection evaluation module 230 is further configured to determine the client by checking the RFCDES.RFCOPTIONS to identify the M parameter (i.e., a customer, or a mandate). Moreover, for all settings, module 230 can write RFCOPTIONS from RFCDES table in its full form and for encryption data, module 230 can check .RFCOPTIONS from the RFCDES table. In this instance, module 230 can identify the S parameter that is responsible for encoding process. If its value is set to Y (enabled), then module 230 writes Y into the cell and when there is no parameter or it is set to N, module 230 writes an N into the cell.

In this instance, the connection evaluation module 230 will categorize the threat type for this connection as “real” and calculate the connection weight according to the following algorithm and obtaining the relevant connection weight from Table 1, as discussed above. Specifically, if the user name field has any values (except null); while Password and Trust connection are set to Y, then module 230 determines its weight value to be the value for ABAPRFC_ConnWeight_withPass defined in Table 1. If the user name field has any values (except null); while Encryption and Trust are set to Y and N, respectively, then module 230 determines the weight value to be the value for ABAPRFC_ConnWeight_withEncr defined in Table 1. If the User name and Connection settings fields have any values (except null); while Encryption and Trust connection are set to Y and N, respectively, then module 230 determines the weight value for the connection to be the value for ABAPRFC_ConnWeight_withEncr_withProxy, as defined in Table 1. If the User name field has any values (except null); while Encryption is set to either N or null, value of Connection settings is N (not null), and Trust connection value is N, then module 230 determines the weight value for the connection to be the value for ABAPRFC_ConnWeight_withProxy, as defined in Table 1. If the User name field has any values (except null); while Encryption is set to either N or null, and the value of Trust connection is N, then module 230 determines the weight value for the connection to be the value for ABAPRFC_ConnWeight withUser, as defined in Table 1. In all other cases, module 230 determines the weight value to be the value for ABAPRFC_ConnWeight_null, as defined in Table 1.

As further noted above, the next connection that can be evaluated by the connection evaluation module 230 according to an exemplary aspect is the SAP NetWeaver ABAP Database (DBCON) Connections. In this instance, the module 230 is configured to read data in the DBCON table, line by line, to obtain details about these connections. In particular, the module 230 can obtain the connection name from the CON_NAME field of the DBCON table. Moreover, the SID source can be obtained by launching an External RFC function rfc MSS_GET_SY_SYSID to obtain the SID in its response. The host source (IP or hostname—) is obtained as the IP of a host being scanned. The server type source is always ABAP and the SID destination is the value of the DBNAME parameter from CON_ENV field of the DBCON table. The host destination (IP or hostname) is the value of SERVER parameter from the CON_ENV field of the DBCON table and the destination port is the value of the SERVER parameter from the CON_ENV field of the DBCON table. Moreover, module 230 is configured to determine the server type destination from the DBMS and the connection type from the database connection. Furthermore, the user name is obtained from the USER_NAME field, the password (if not empty) is determine as the value is Y, and, if empty, then N. The database Owner is the database Owner value from CON_ENV.

In this instance, the connection evaluation module 230 will categorize the threat type for this connection as “real” and calculate the connection weight according to the following algorithm and obtaining the relevant connection weight from Table 1, as discussed above. It should be appreciated that all the above-mentioned fields should be filled in before beginning to perform this procedure step. In particular, module 230 is configured to check the filled table fields related to the given connection. In accordance with an exemplary aspect, if the User name field is set to any value (except null); and the value of Password is Y, then module 230 assigns the weight of the connection to the value of ABAPDBCON_ConnWeight_withPass, as noted above in Table 1. Moreover, if the User name field is set to any value (except null); and the value of Password is N, then module 230 set the weight of the connection to the value of ABAPDBCON_ConnWeight_withUser, as set forth in Table 1. In all other cases, the module 230 sets weight value of the connection to ABAPDBCON_ConnWeight_null.

According to another aspect, the connection evaluation module 230 is further configured to obtain information about SAP NetWeaver ABAP SOA Connections. In this aspect, information about SOA connections can be obtained from the following service: /sap/bc/webdynpro/sap/appl_soap_management installed on SAP NetWeaver ABAP application server. For example, module 230 can be configured to open the URL, select “Management Connections”, and then select each table row and, depending on the data presented in this row, module 230 can fill the information about connections.

In this aspect, the module 230 is configured to review of acquired data and fill a final table. More particularly, module 230 can search for input tags with ct=“11” in the HTTP response, i.e., there will be 23 of them, although some are not needed for the task. Module 230 then writes the value of the first tag found into the final table (in the field SID destination), writes the next input with ct=“11” into Client, and then skips inputs before reading the fourth one and writing it into Connection name. Next, module 230 writes one input again and write the value of the sixth value into Host destination (IP or host name). The next value of the next input is written into in Destination port and the value of the next input in written to Connection Type. Furthermore, the host source (IP or hostname) is taken from the system itself and the server type source can be ABAP SOA.

According to another aspect, the connection evaluation module 230 is further configured to obtain information about SAP NetWeaver J2EE RFC Connections (for SAP Versions below 7.30). According to this aspect, module 230 can obtain this information from the SAP NetWevver J2EE Configuration. Accordingly, the connection name can be obtained from ProgramId, the SID source and Host source (IP or hostname) is obtained from the scanner, the server type source is SAP JAVA, and the host destination (IP or hostname) is obtained from ApplicationServerHost or from GatewayHost (if it is set to null). Moreover, the module 230 is configured to identify the Connection Type as JCo RFC, the user name from the User of the application, and the client from the specific client. Moreover, similar to above, the Password parameter is N if it set to null, and otherwise is Y and the Encryption is N if UseSnc is set to false, and otherwise is Y. Moreover, the Destination Port is checked as the SystemNumber. If it is not set to null, module 230 writes it in the port, otherwise GatewayService should be checked.

According to this aspect, the connection evaluation module 230 is configured to determine the connection weight using Table 1. In particular, if the User name has any value (except null), and the Password is set to Y, then the module 230 sets the weight value as J2EERFC_ConnWeight_withPass, obtained from Table 1. If the User name has any value (except null), while Password and Encryption are set to N, then the module 230 sets the weight value to J2EERFC_ConnWeight_withUser, from Table 1. If User name has any value (except null), while Password and Encryption are set to N and Y, respectively, then module 230 sets the value of the weight for the connection to J2EERFC_ConnWeight_withUser_withEncr, as set forth in Table 1. In all other cases, module 230 sets the weight for this connection to J2EERFC_ConnWeight_null.

According to another aspect, the connection evaluation module 230 is further configured to obtain information about SAP BOBJ DataServices Connections. In this aspect, module 230 can obtain the information about SOA(“service-oriented architecture”) connections from the following service: /DataServices/servlet/web services installed on the SAP BOBJ application server. In one exemplary aspect, the following request can be sent to the provided URL:

<soapenv:Envelopexmlns:soapenv=“http://schemas.xmlsoap.org/soap/envelope/”
xmlns:ser=“http://www.businessobjects.com/DataServices/ServerX.xsd”>

<soapenv:Header>

<ser:session>

<SessionID>(The SessionID) </SessionID>

</ser:session>

```
  </soapenv:Header>
  <soapenv:Body>
```

<ser:GetListOfRepositoriesRequest/>
</soapenv:Body>

</soapenv:Envelope>

The above-noted service contains a list of repositories, with each of them having its own set of parameters, which should be put into the final table. Thus, the connection evaluation module 230 is configured to fill the table, according to the following principle. First, module 230 is configured to obtain the connection name from repoName parameter and the host source (IP or hostname) from the IP of a host being scanned. Moreover, the server type source is defined as “SAP BO DataServices”. The host destination (IP or hostname) is obtained from dbHost parameter and the server type destination is obtained from dbType parameter. The connection Type is defined as “JDBC” and the user name is obtained from username parameter.

In this aspect, the connection evaluation module 230 defines the threat type of the connection as “real” and obtains the weight value of the connection according to the following algorithm. Specifically, if the User name is null, module 230 determines the weight value from Table to be the value of BOBJDS_ConnWeight_withUser. In all other case, the weight value for this connection is defined according to the following value BOBJDS_ConnWeight from Table 1.

According to another aspect, the connection evaluation module 230 is further configured to obtain information about SAP BOBJ Services Connections. In general, for a connection to be established, the application is required to connect to port 6400 of a BOBJ Server and send the following request: SELECT*FROM CI_SYSTEMOBJECTS, where SI_KIND=‘Server’. Depending on the response, module 230 can obtain the following data, including the connection name as obj.getTitle( ) the host source (IP or hostname) as the IP of a host being scanned, and the server type source as “SAP BOBJ”. Moreover, the host destination (IP or hostname) is obtained by getting the IP from obj.properties( ).getString (“SI_REGISTER_TO_APS”) and the destination Port is obtained by getting PORT from obj.properties( ).getString(“SI_REGISTER_TO_APS”). The Connection Type is defined as “GIOP” and the Connection Owner is obtained from the value of obj.properties( ).getString (“SI_OWNER”). In this instance, module 230 is configured to define the connection weight value for each connection as the value from the BOBJ ConnWeight parameter value from Table 1.

According to an aspect, the connection evaluation module 230 is further configured to obtain information about SAP BOBJ Federations Connections. For these types of connections to be established, the application is required to connect to port 6400 of BOBJ Server and send the following request: SELECT*FROM CI_SYSTEMOBJECTS where SI_KIND=‘RemoteCluster’. Depending on the response, module 230 can obtain the following data, including the connection name as obj.getTitle( ) and the host source (IP or hostname) as the IP address of the host being scanned. Moreover, the server type source is defined as “SAP BOBJ Federations” and the host destination (IP or hostname) is obtained from obj.properties( ). getString(“SI CLUSTER NAME”). The destination Port is obtained from obj.properties( ) getString(“SI_CLUSTER_NAME”) and the Connection Type is defined as GIOP. Furthermore, the user name can be obtained from obj.properties( ).getString(“SI_USERNAME”) and the Destination Service can be obtained from obj .properties( ).getString(“SI_CLUSTER_URI”). An Authentication Method is further obtained for this connection by acquiring obj.properties( ). getString(“SI_AUTH_TYPE”). If secLDAP, module 230 outputs LDAP; if secEnterprise, module 230 outputs Enterprise; if secWinAD, module 230 outputs Windows AD; if secSAPR3, module 230 outputs SAP; if secPSE1, module 230 outputs JD Edwards EnterpriseOne; if secOraApps, module 230 outputs Oracle EBS; if secpsenterprise, module 230 outputs PeopleSoft Enterprise; and if secSiebel7, module 230 outputs Siebel7. Moreover, the Connection Owner is obtained by the obj.properties( ).getString(“SI_OWNER”). In this aspect, module 230 is configured to define the Connection Weight according to the following algorithm. If the User name parameter is set to any value (except null), module 230 sets the weight value of a connection to the value of BOBJF_ConnWeight_withUser as defined in Table 1. In all other cases, the module 230 sets the weight value for this connect to the value of BOBJF_ConnWeight in Table 1.

According to yet another aspect, the connection evaluation module 230 is further configured to obtain information about Oracle Database links. To do so, module 230 connects to the Oracle Database and gathers data from table dba_db_links table. Module 230 then populates a table of information for this connection from the following data. In particular, the connection name is defined as “db_link fiel from dba_db_links” and the host source (IP or hostname) is obtained as the IP address of the host being scanned. Moreover, the server type source is “Oracle”, the host destination (IP or hostname) is obtained by searching HOST value from dba_db_links, and the destination Port is obtained by searching PORT value from dba_db links. The user name is obtained from the username field from dba_db_links and the Database Owner is obtained from dba_db_links field. The server type destination is obtained from the dba_db_links.HOST and the connection type is obtained from dba_db_links.HOST. Particularly, it is obtained from the value jdbc jdbc:oracle:thin://172.16.30.63:1527/DM0, providing that in dba_db_links.HOST there is such a line: jdbc:oracle:thin://172.16.30.63:1527/DM0. If there is none, then module 230 writes DB as the connection type. Furthermore, the module 230 is configured to obtain the SID destination from dba_db_links.HOST, and, in particular, the value DMO jdbc:oracle:thin://172.16.30.63:1527/DM0, provided that, in dba db links.HOST, there is a line of the following kind: jdbc:oracle:thin://172.16.30.63:1527/DMO. Alternatively, if there are no matches, module 230 attempts to get the value of SID as (DESCRIPTION=(ADDRESS=(PROTOCOL=TCP) (HOST=10.2.10.18) (PORT=1525)) (CONNECT_DATA=(SID=test10))). If there are no results, module 230 adds nothing. Furthermore, module 230 is configured to obtain the encryption information by checking the value PORT=. In case it is set to tcps, module 230 writes Y into a cell. Otherwise, module 230 leaves this cell in the table unchanged. If it is set to TCP, module 230 writes N in this cell.

In this aspect, the connection evaluation module 230 is configured to determine the connection weight for the connection by checking values of the parameters in the table. If User name is set to any value (except null), while the value of Encryption is Y, module 230 outputs the value DB_ConnWeight_ORCL_withUser withEncr, as set forth in Table 1. If User name is set to any value (except null), while value of Encryption is either N or null (empty), module 230 outputs the value DB_ConnWeight_ORCL_withUser as defined in Table 1. In all other cases, the module 230 sets the value of this connection from the value DB_ConnWeight_ORCL in Table 1.

According to yet another aspect, the connection evaluation module 230 is further configured to obtain information about HANA links by connecting to HANA Database and sending the following request: “select*from sys.REMOTE_SOURCES”, for example. Upon getting a list of connections, module 230 is configured analyse values in the CONNECTION_INFO column to obtain the following properties.

<PropertyEntry name=“dsn”>11</PropertyEntry>

<PropertyEntry name=“adapter config file”>property_orcl.ini</PropertyEntry>

<PropertyEntry name=“server”>111</PropertyEntry>

<PropertyEntry name=“port”>11</PropertyEntry>

In this aspect, the connection evaluation module 230 is configured to obtain the following specific details for this connection, including the connection name from the NAME field from remote_source table, the host source (IP or hostname) as the IP address of the host being scanned, the server type source as “SAP HANA”, the host destination (IP or hostname) as the value from <PropertyEntry name=“server”>, the server type destination as the adapter_name, and the Connection Type as DB. In this aspect, module 230 is configured to define the connection weight for each connection as the value of the DB_ConnWeight_HANA parameter from Table 1.

According to an additional aspect, the connection evaluation module 230 is further configured to obtain information about SAP Mobile Platform Connections. To do so, module 230 is configured to connect to SAP Mobile Platform Service /Admin/AdminData and request a response with connections information. The module 230 can then parse the response using the following algorithm, including identifying the connection name as the endPointName parameter value from response and the SID source from the scanner. Moreover, the host source (IP or hostname) is obtained as the IP address of the host being scanned and the server type source is defined as “SMP”. For the host destination (IP or hostname) from endPointAddress, module 230 obtains the value between http(s):// and /. If there is no http(s)://, module 230 obtains the value placed before first /. Otherwise, module 230 writes in the whole line. In addition, the connection type is defined as “SMP” and the user name is obtained from the userName parameter value in the response. For the password, if it is set to any value (except null), then module 230 writes Y in the appropriate cell and otherwise an N. Finally, the encryption is obtained by checking the endPointAddress parameter value from response and, if there is HTTPS there, then Y, otherwise it is assigned a value N.

Based on this information, the connection evaluation module 230 is further configured to determine the connection weight value for this connection according to the following algorithm. If User name is set to any value (except null), and Password has a value of Y, then the module 230 sets the weight value as the value from SMP_ConnWeight_withPass of Table 1. If User name is set to any value (except null); while Password and Encryption have value of N, then module 230 sets the weight value for this connection to the value of SMP ConnWeight withUser, as defined in Table 1. If User name is not null and Password is N and Encryption is Y, then module 230 sets the weight value for this connection to the value of SMP_ConnWeight_withUser_withEncr, as set forth in Table 1. In all other cases, the module 230 sets the weight value of this connection to SMP_ConnWeight_null.

According to an additional aspect, the connection evaluation module 230 is further configured to obtain information about SAP PI Integration Builder Links. In this aspect, the information can be obtained by module 230 from SAP NetWevver J2EE platform Configuration by executing specific methods of API. Alternatively, this data can be collected by connecting to the Admin Interface. In this aspect, the connection name is obtained from the chnl.getChannel( ), the host source (IP or hostname) is obtained from the IP address of the host being scanned, and the server type source is defined as “SAP PI”. Moreover, the host destination (IP or hostname) is defined according to the following algorithm:
If chnl.getMsgProt( )=RFC, the module 230 obtains the host destination from Attrs: applicationServer.
If chnl.getMsgProt( )=XI, the module 230 obtains the host destination from Attrs: host.
If chnl.getMsgProt( )=plainHTTP, the module 230 obtains the host destination from Attrs: host, if host null, and module checks httpDestination from Attrs.
If chnl.getMsgProt( )=File, the module 230 obtains the host destination from Attrs: file.targetDir.
If chnl.getMsgProt( )=WS, the module 230 obtains the host destination from Attrs: WSDLUrl (e.g., a line can look lie this “WSDLUrl |http://www.sap.com/webas/710/soap/features/transportbinding/=http://172.16.30.78:50000/x?wsdl”a necessary value follows=).
If chnl.getMsgProt( )=SOAP, module 230 checks XMBWS.TargetURL.
If chnl.getMsgProt( )=Idoc, the module 230 obtains the host destination from rfcDestination.
If chnl.getMsgProt( )=RNIF, the module 230 obtains the host destination from k httpDestination.
If chnl.getMsgProt( )=XML SQL, the module 230 obtains the host destination from jdbcDriver (i.e., jdbcDriver=jdbc:oracle:thin: 172.16.0.136: 1521/HC). These values should be output either with dots (for ips) or with characters, contained between such symbols, as: // or :. If there are no matches, module 230 returns a full line.
If chnl.getMsgProt( )=MML, the module 230 obtains the host destination from JMSOutboundQueue.
If chnl.getMsgProt( )=JMS (a response contains JMS1.x, therefore module 230 searches matches for JSM), and module 230 checks parameters SonicServer or WSMQServer, or WASProviderEndPoints, or JNDIProviderURL. One of them should be set to any value, but null, therefore it is output it. If WASProviderEndPoints is set to any value (except null), module 230 take the first part of parameter, like: IP:PORT: . . . (localhost:7276:BootstrapBasicMessaging), and outputs localhost here. If JNDIProviderURL is set to any value (except null), module 230 takes the first value (right before :), for example, host:port (JNDIProviderURL=localhost:50010—and module 230 puts localhost into a table).
IF chnl.getMsgProt( )=IDOCXML, the module 230 obtains the host destination from ServerName.
If chnl.getMsgProt( )=XIALL, the module 230 obtains the host destination from OMail.TargetURL.
If chnl.getMsgProt( )=RFC-XML, the module 230 obtains the host destination from URL.
If chnl.getMsgProt( )=POST, the module 230 obtains the host destination from Attrs: host. Moreover, additional processing of host parameter, analysis and removing of spare values: 1) If there is http(s):// or : or http(s) and /, module 230 uses a value between them; if there is no : or /, and uses a value, which follows :// 2) If there is ws(s):// and: or ws(s) and /, module 230 uses a value between them; if there is no : or /, uses a value after :// 3) If there is no http(s) or ws(s):// , while there is : or /, module 230 uses a value before : or / 4) In all other cases, module 230 changes nothing.

Moreover, according to this aspect, the connection evaluation module 230 defines the connection type as information taken from chnl.getTrnsProt( ). Moreover, the user name is defined according to the following algorithm:
If chnl.getMsgProt( )=RFC or XI, or plainHTTP, or POST, module 230 checks Attrs: logonUser.
If chnl.getMsgProt( )=File, module 230 checks Attrs: ftp.user.
If chnl.getMsgProt( )=WS, module 230 checks MetaDataAccess.Username.
If chnl.getMsgProt( )=SOAP, module 230 checks XMBWS.User.
If chnl.getMsgProt( )=RNIF, module 230 checks logonUser.
If chnl.getMsgProt( )=XML_SQL, module 230 checks dbuser.
If chnl.getMsgProt( )=MML, module 230 checks LogonUser or JMSOutboundQueue.
If chnl.getMsgProt( )=JMS (response should contain JMS1.x, therefore module 230 searches matches via JSM), module 230 checks parameter JMSQueueFactoryUser, while outputting the second value of a parameter, if there is parameter JMSQueueFactoryUser, which is set to any value (except null).
If chnl.getMsgProt( )=IDOCXML, module 230 checks UserName.
If chnl.getMsgProt( )=XIALL or XIPAYLOAD, module 230 checks OMail.User.
If chnl.getMsgProt( )=RFC-XML, module 230 checks LogonUser.

Moreover, according to the exemplary aspect, the connection evaluation module 230 is further configured to obtain the password information about SAP PI Integration Builder Links according to the following algorithm:
If chnl.getMsgProt( )=XI or plainHTTP, or POST, or RFC, module 230 checks logonPassword from Attrs, logonPassword=com.sap.aii.utilxi.cpa.generic. PasswordValue@. If there is no @ (or null) after @, a password is set, this cell returns Y, and N, otherwise.
If chnl.getMsgProt( )=SOAP, module 230 checks the value of XMBWS.Password. (XMBWS.Password=com.sap.aii.utilxi.cpa.generic.PasswordValue@) in Atrrs. If 0 (or null) does not follow com.sap.aii.utilxi.cpa.generic.PasswordValue@, a password is set, Y is returned in this cell, otherwise N is returned.
If chnl.getMsgProt( )=RNIF, module 230 checks logonPassword from Attrs. logonPassword=com.sap.aii.utilxi.cpa.generic.PasswordValue@ if 0 (or null) does not follow @, a password Is set, and Y Is returned in this cell. Otherwise N is returned.
If chnl.getMsgProt( )=XML_SQL, module 230 checks dbpassword from Attrs, dbpassword=com.sap.aii.utilxi.cpa.generic.PasswordValue@ of 0 (or null) does not follow @, a password is set, and this cell returns Y. Otherwise N is returned.
If chnl.getMsgProt( )=JMS, module 230 checks parameter JMSQueueFactoryPassword. If 0 does not follow PasswordValue, and the value of the latter is higher than 0, Y is returned in this cell. Otherwise N is returned. However, if there is parameter JNDISecurityCredentials, which is set to any value but 0, module 230 outputs Y.
If chnl.getMsgProt( )=IDOCXML, module 230 checks the value of the Password (Password=com.sap.aii.utilxi.cpa.generic.PasswordValue@) parameter in Atrrs. If there is any value, but 0, after PasswordValue@, module 230 returns Y in this cell, and otherwise an N is returned.
If chnl.getMsgProt( )=XIALL XIPAYLOAD, module 230 checks the value of parameter OMail .Password (OMail.Password=com.sap.aii.utilxi.cpa.generic. PasswordValue@) in Atrrs, if there is any value, but 0, after PasswordValue@, then module 230 returns 0 in this cell and otherwise an N is returned.
If chnl.getMsgProt( )=RFC-XML, module 230 checks the value of parameter LogonPassword (LogonPassword=com.sap.aii.utilxi.cpa.generic.PasswordValue@) in Atrrs. If there is any value, but 0 after PasswordValue@, module 230 returns a Y in this cell and otherwise an N is returned.
If chnl.getMsgProt( )=MML, module 230 checks the value of parameter LogonPassword (LogonP as sword=com.sap.aui.utilxi.cpa.generic.PasswordValue@) in Atrrs. If there is any value, but 0, after PasswordValue@, module 230 returns a Y in this cell and otherwise returns an N. **E chnl.getMsgProt( )=WS, module 230 checks the value of MetaDataAccess.Password (MetaDataAccess.Password=com.sap.aii.utilxi.cpa.generic. PasswordValue@ or MetaDataAccess.Password |http://www.sapcom/webas/630/soap/features/authentication/=com.sap.aii.utilxi.cpa.g eneric.PasswordValue@) in Atrrs. If there is any value, but 0, after PasswordValue@, module return Y in this cell and otherwise returns a N.

According to the exemplary aspect, the connection evaluation module 230 is further configured to determine the proxy host for this connection based on the following algorithm. If chnl.getMsgProt( )=XI ot plainHTTP, or POST, module 230 takes the value from Attrs: proxyHost. If chnl.getMsgProt( )=SOAP XMBWS.ProxyHost. Moreover, according to this aspect, the proxy port value should be stored in string data type value, as some value can be stored as strings for unclear reasons. Additionally if a value is either null or indefinite, a numerical value 0 should not be returned (module 230 outputs nothing), i.e., if chnl.getMsgProt( )=XI or plainHTTP, or POST, module 230 takes Proxy port from Attrs: proxyPort, and if chnl.getMsgProt( )=SOAP, a parameter is XMBWS.ProxyPort. For a proxy user:

If chnl.getMsgProt( )=XI or plainHTTP, or POST, Proxy user is taken from Attrs: proxyUser, if chnl.getMsgProt( )=SOAP, a parameter is XMBWS.ProxyUser, and for a proxy password, the module 230 checks values of proxyPassword for XI or plainHTTP, or POST (or for SOAP XMBWS.ProxyPassword=com.sap.aii.utilxi.cpa.generic.PasswordValue), in Atrrs. If there is any value after PasswordValue, which is higher, than 0, and is not equal to @0. We return Y in this cell and otherwise an N is returned.

According to the exemplary aspect, the connection evaluation module 230 is further configured to obtain the encryption information about SAP PI Integration Builder Links according to the following algorithm.
If chnl.getMsgProt( )=RFC, module 230 checks authenticationModeBasicSNC from Attrs, and, if it is set to SNC, encryption is enabled and a Y is returned for the cell.
If chnl.getMsgProt( )=FTP, module 230 checks ftp.security from Attrs, of there is ftps_control or ftps_control data there, and module 230 returns Y. If there is none, module 230 returns an N for the encryption cell.
If chnl.getMsgProt( )=WS, module 230 checks TransportGuaranteeMethod (TransportGuaranteeMethod|http://www.sap.com/webas/630/soap/features/transportg uarantee/=) and it is responsible for encryption type.
If it is set to SSL, AsymmSigEnc or SymmSigEnc, module 230 checks SecureConversation (SecureConversation http://www.sap.com/webas/630/soap/features/transportguarantee/=) if its value is 1, encryption is enabled and module 230 returns Y and puts a value TransportGuaranteeMethod into Encryption type. If it is set to 0, module 230 outputs an N.
If chnl.getMsgProt( )=RNIF, module 230 checks the value of chnl.getTrnsProt( ). If it is HTTPS, then a Y is provided and if it is HTTP, then an N is output.
If chnl.getMsgProt( )=MML, module 230 checks the value of chnl.getTrnsProt( )and if it is HTTPS or SonicMQ, then Y is output and if HTTP, then N is output.
If chnl.getMsgProt( )=JMS, module 230 checks parameter UseSSL and if it is set to 1, module 230 returns a Y.
If chnl.getMsgProt( )=IDOCXML, module 230 checks SNCMode and returns a Y if it is 1.
If chnl.getMsgProt( )=XIALL or XIPAYLOAD, then module 230 checks OMail.Authentication, and if it is CRAM-MD5, then a Y is output.
If chnl.getMsgProt( )=RFC-XML, module 230 checks the value of chnl.getTrnsProt( ) and if it is HTTPS, then a Y is output and if HTTP an N is output.

According to the exemplary aspect, the connection evaluation module 230 is further configured to obtain the encryption type about SAP PI Integration Builder Links according to the following algorithm. Namely, if chnl.getMsgProt( )=JMS, then module 230 checks parameter UseSSL and if it set to 1, module 230 returns the value of parameter SSLCipherSuiteWSMQ. Moreover, if chnl.getMsgProt( )=XIALL or XIPAYLOAD, module 230 checks OMail.Authentication and if there is CRAM-MD5, it is output as the value. Otherwise, module 230 does not output a value.

Moreover, according to this aspect, the connection settings are obtained from chnl.getService( )and the destination service is obtained from Attrs: path. Moreover, the client is obtained from Attrs: logonClient. If there is no parameter of the kind, module 230 is further configured to check SAPClient and if a customer value is indefinite or equal to 0, module 230 outputs nothing.

Furthermore, the connection evaluation module 230 is configured to obtain the destination port value and store it in a string data type, as some values for unclear reasons can be stored as a string. Additionally, a value is either null or indefinite, a numerical 0 value should not be returned (nothing is output). In this aspect, the connection evaluation module 230 is configured to perform the following algorithm:
If chnl.getMsgProt( )=XI or POST, or plainHTTP, module 230 checks the port parameter.
If chnl.getMsgProt( )=ftp, module 230 checks parameter ftp.port.
If chnl.getMsgProt( )=WS, module 230 checks parameter URLPort (it may also look this way URLPort |http://www.sap.com/webas/710/soap/features/transportbinding/).
If chnl.getMsgProt( )=RFC, module 230 checks parameter systemNumber.
If chnl.getMsgProt( )=Idoc, module 230 checks parameter port.
If chnl.getMsgProt( )=XML_SQL, module 230 checks jdbcDriver. (jdbcDriver=jdbc:oracle:thin:@172.16.0.136:1521/HC), and module 230 tries to obtain the value between: and /. There should be a numerical value there and if module 230 is unable to get this kind of data (e.g. there is no : or /), module 230 sreturn the whole string. If there is :, but no /, and a numerical value follows :, then it is a port.
If chnl.getMsgProt( )=JMS, module 230 checks parameter SonicServer, or WSMQServer, or WASProviderEndPoints, or JNDIProviderURL. One of them should not be set to null. It is the parameter to be output. If WASProviderEndPoints is not set to null, then module 230 takes the second part of the parameter between :. It can look this way IP:PORT: . . ._(localhost:7276:BootstrapBasicMessaging). Here, module 230 outputs 7276. If the value JNDIProviderURL is not equal to null, module 230 takes a value after “:”. It can look this way host:port (JNDIProviderURL=localhost:50010—in which module 230 puts 50010 into the table).

Based on the foregoing data obtained for the each SAP PI Integration Builder Link, the connection evaluation module 230 by checking the fields in the table. Additionally, module 230 checks the certificates of this connection to establish connection with a server via a certificate. In this view, module 230 creates variable usedCertificate=0, and checks the following parameters: AuthenticationModeHTTPS, AuthenticationMode,ftp.security.useClient Cert, useCert, enableClientCertificate. If this connection has at least one of these parameters (either one of them or 0), which is set to either 1 or certificate, depending on a type of connection (possible types of connections are listed below), then the module 230 determines the usedCertificate=1. Otherwise, the module 230 determines the usedCertificate=0. The connection evaluation module 230 defines the weight value for this connection according to the following algorithm:
If fields (User name is set to null or Password Y) or (usedCertificate=1), then the module 230 selects the value from the PI_ConnWeight_withPass, as defined in Table 1, as the weight value for this connection.
If fields User name and Proxy host, Proxy user are set to any value (except null), and Proxy password=Y, while Encryption has value of N or null, then the module 230 selects the value from the PI_ConnWeight_withUser withProxyPasss, as defined in Table 1, as the weight value for this connection.
If fields User name and Proxy host are set to any value (except null), and the value of Encryption is N or null, then the module 230 selects the value from the PI_ConnWeight_withUser_withProxy, as defined in Table 1, as the weight value for this connection.
If field User name and Proxy host are set to any value (except null) and the value of Encryption is Y, then the module 230 selects the value from the PI_ConnWeight_withUser withProxy_withEncr, as defined in Table 1, as the weight value for this connection.
If User name is set to any value (except null), and the value of Encryption is Y, then the module 230 selects the value from the PI_ConnWeight_withUser_withEncr, as defined in Table 1, as the weight value for this connection.
If User name is set to any value (except null), and the value of Encryption is N or null, then the module 230 selects the value from the PI_ConnWeight_withUser, as defined in Table 1, as the weight value for this connection.
In all other cases, the module 230 selects the value PI_ConnWeight, as defined in Table 1, as the weight value for this connection.

According to an additional aspect, the connection evaluation module 230 is further configured to information about SAP xMII Links. In this aspect, the module 230 is configured to connect to the SAP xMII Webserver using the following URL, for example:
/webdynpro/resources/sap.com/xapps˜xmii˜ui˜admin˜navigation/NavigationApplication ?view=com.sap.itsam.cfg.mii.admin.Connections&deployable=sap.com/xapps˜xmii˜ui˜admin˜dataservices&component=com.sap.xapps.xmii.ui.admin.dataservices.dataserverco mp.DataServicesComp&title=%D0%A1%D0%BE%D0%B5%D0%B4%D0%B8%D0% BD%D0%B5%D0%BD%D0%B8%D1%8F HTTP/1.1

Once accessed, the module 230 is configured to select the 1st line of table of connections of which the following connection types are possible: BC, CR, EJB, FTP, JCO, JMS, MAIL, WAS. For each connection type, module 230 is configured to obtain information about connection values. To fill the table relating to information of this connection, module 230 use the following algorithm for each connection. First, the connection name is obtained from the KPDHELOJ. SystemConnectionsView.connectionNameparameter value. Moreover, the SID source is obtained from the scanner and the host source (IP or hostname) is obtained from the scanner. The server type source is defined as “SAP MII” and the host destination (IP or hostname) is obtained from KPDHELOJ.SystemConnectionsView.inpSERVER. The server type destination is defined such that for each type, module 230 adds a value after a hyphen, for example BC-SAP Business Connector; WAS—SAP NetWeaver Application Server; JCO—SAP Java Connector; FTP—File Transfer Protocol; MAIL—E-mail; JMS—Java Message Service; EJB—Enterprise JavaBeans; and CR—Crystal Reports HANA SDA. Moreover, the connection type can be defined as one of the following values: BC, CR, EJB, FTP, JCO, JMS, MAIL, WAS. The encryption is obtained from the KPDHELOJ.SystemConnectionsView.inpSSL, and, if true, module 230 puts Y back and otherwise leaves N in the cell of the table. Moreover, the client is obtained from the KPDHELOJ.SystemConnectionsView.inpCLIENT, the destination port is obtained from the KPDHELOJ.SystemConnectionsView.inpPORT, and the destination service is obtained from the KPDHELOJ. SystemConnectionsView.inpURL. In this aspect, the module 230 is configured to define the connection weight as the value of MIT ConnWeight withEncr from Table 1 if the encryption for this connection is set to Y. Otherwise, if the encryption value in the table is either N or null, module 230 selects the value of MII_ConnWeight_withEncr from Table 1 as the encryption value of the connection.

Once the connection determination module 220 identifies all potential connections and connection evaluation module 230 obtains data relating to each real connection and identifies a connection weight for each such connection applying the values from Table 1, as discussed above, the risk correlation module 240 is configured to prioritize all issues, not only by measuring criticality or probability of a particular vulnerability, but also by taking into account that the presence/non-presence or even details of one issue can affect criticality or probability of another issue, especially when dealing with multi-stage attacks. In other words, the risk correlation module 240 is configured to determine that issues of the enterprise application really exists in order to understand what risks bears its exploitation. The risks in general are calculated by the number of different values such as criticality, probability of exploitation, CVSS (“common vulnerability scoring system”), existence of a real exploit in the Internet, the number of attackers who can exploit this issue (plus their time and money expanses), and other factors, like information about correlation of different vulnerabilities.

For example, if the issue collection module 210 identifies a XSS (“cross-site scripting”) vulnerability, its criticality is known to be high and the probability of exploitation is medium. However, of the computer 110 further determines that application configuration parameters are enabled that prevent or minimize the risk of XSS vulnerability, the risk correlation module 240 is configured to change the probability of exploitation or criticality depending on a parameter value. Thus, the final risk of XSS vulnerability will be lower, and probably it will be so low that the system does not need to patch it and, as the result, we will save time.

According to another example, if the issue collection module 210 identifies directory traversal file read vulnerability, the criticality will be high because we can read any file on OS and the probability will also be high. However, if the application is enabled with configuration parameters that protect it from unauthorized access to OS, an attacker will be able to get read access only to specific files and directories, so criticality will be medium or even low. As a result, the risk of directory traversal vulnerability will also be lower. As a result, the risk correlation module 240 will set the final risk will to be much lower and a user may have no need to patch this vulnerability.

Thus, according to an exemplary aspect, risk correlation can be provided, if a user can scan levels of system security in multiple areas. For example, if the user can scan configuration checks and source code vulnerabilities, the risk correlation module 240 can change risks of source code vulnerabilities according to information gathered during configuration checks. According to one example, if the computer 110 scans for access control issues and collects data about events, the risk correlation module 240 can tell not only who has critical rights in the system, but also which user really should have those rights taking into account event logs where the risk correlation module 240 can get information about transaction history. In another example, source code vulnerabilities risk can be modified according to information from access control or from configuration checks. Further, with regard to configuration checks, the risk correlation module 240 can analyze how they affect all input validation vulnerabilities. For access control checks, the risk correlation module 240 can analyze how they affect unauthorized access vulnerabilities. Moreover, information about events such as potential attack can be correlated with information about vulnerabilities to understand if this attack can happen or this attack is failed because vulnerability is patched.

According to the exemplary aspect, the risk correlation module 240 is configured to calculate the risk of an identified security issue. In particular, regardless of the issue type, the risk correlation module 240 calculates the risk based on the following formula: Risk_value=(Base_Criticality+Correlated_Criticality)*(Base_Probability*Correlated_Probability). In this instance, the Base Criticality of the issue is a number from 1 to 4 based on computer 110's knowledgebase for every vulnerability. Moreover, the Base_Probability is a number from 1 to 4 provided in the computer 110's knowledgebase for every vulnerability as to how probably the vulnerability was result in a security issue. The Correlated_Criticality is a value that exists only for a vulnerability that can depend on another vulnerability and is a value from 0 to 4. The Correlated_Probability is a value that exists only for a vulnerability which can depend on another vulnerability and is a value from 0 to 4. Depending on the Risk value, the computer 110 is configured to inform the user whether the risk is high, medium or low. For example, if Risk_value is from 1 to 4, the Risk=Low; if Risk_value is from 5 to 8, the Risk=Medium; if Risk_value is from 9 to 12, the Risk=High; and if Risk_value is from 13 to 16, the Risk=Critical.

After collecting all information discussed above, the prioritization module 250 is configured to prioritize remediation actions for a client/enterprise application. In simplest form, the prioritization module 250 determines the weakest application and which application should be pathed first, i.e., the order of such remediation actions.

In particular, the prioritization module 250 is configured to map all connections in the system (e.g., the environment shown in FIG. 1) to determine, for example, that some applications that are not important for business can have connections with many other applications that are mission-critical. On the other hand, the prioritization module 250 can also determine that some very important applications are isolated and that securing them may be less important. Accordingly, the prioritization module 250 is configured to categorize all systems by priority taking into account all connections and severity of vulnerabilities of connected systems. According to an exemplary aspect, the prioritization module 250 generates a remediation priority index for each vulnerability. In other words, the more probable connections between different applications with higher severity, the higher the remediation priority index.

According to the exemplary aspect, the prioritization module 250 calculates the remediation priority index for each system based on factors including, for example, target system severity, the number of security issues in this system (e.g., vulnerabilities, missing patches, default passwords, and the like), and the number and types connections with other systems (e.g., their type, connection weight, number and severity of connected system).

In this aspect, the remediation priority index can be a value between 1 and 99999999, for example, and calculated according to the following formula: RPI=(10/TSH)*(TSS+Sum (VSS[i]*MPW[i])), where i is a list of all potentially victim systems for the particular target system. For this formula, the following variables are defined:
CW is the connection weight that can be between 0 to 1, as indicated above in Table 1. The connection weight is determined by connection evaluation module 230 as explained in detail above. In essence, the connection weight indicates how easy it is to gain access from one system to another system using this connection.
CW[i] is the list of connection weights between two directly connected systems from max to min.
CWT is the connection weight total, i.e., the weight for all direct connections between two systems CWT=sum(CP[i]/2̂i).
PW is the path weight, which is determined by multiplying all connection weights during one particular path from the target system to victim system, i.e., the PW=CWT[1]*CWT[2] . . . *CWT[I].
MPW is equal to max(PW[i]), which is the maximum value for all possible pathways.
TSH is the target system health (e.g., 1-10) that is calculated based on the number and the types of issues in this application.
TSS is the target system severity (e.g., between 1-4).
VSS is the victim system severity (e.g., between 1-4).

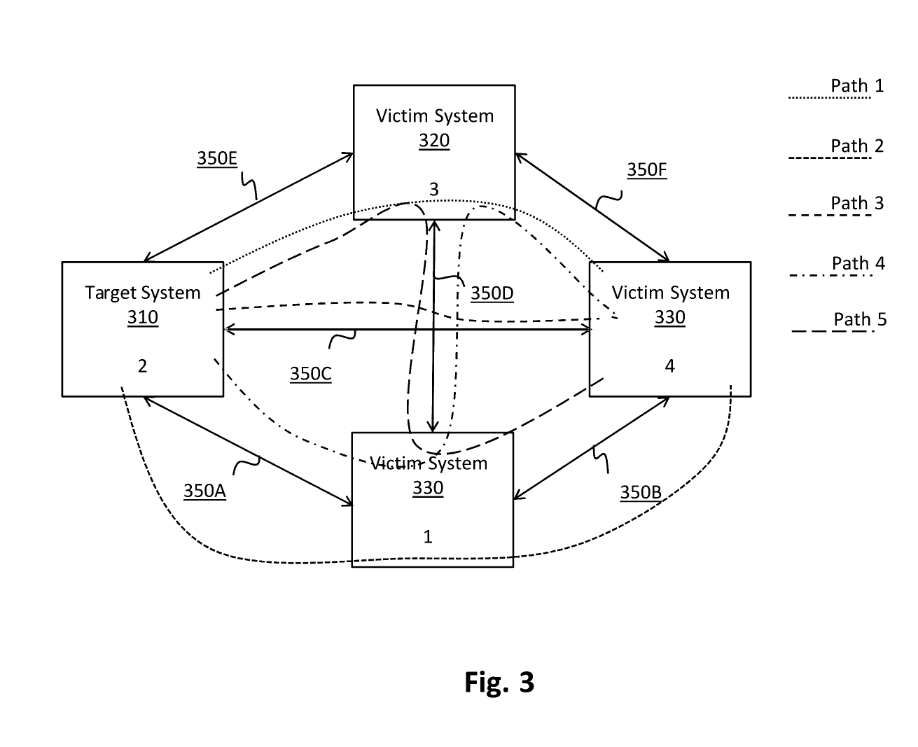

FIG. 3 illustrates a visual depiction of an exemplary distributed system with multiple paths according to an exemplary aspect. As shown, the distributed system includes a target system 310, a first victim system 320, a second victim system 330, and a third victim system 340. In addition, it is presumed that there are connections (i.e., connections 350A through 350F) that connect each of the systems to one another. However, as further shown, there are five potential paths from target system 310 to victim system 340 (i.e., path 1 through path 5 that are indicated with different dashed lines). For purposes of this example, it is presumed that the computer 110 has obtained security related information from each system and includes data that TSH equals 2, meaning that the target system 310 is very insecure; that TSS equals 4 (i.e., very severe) and that VSS equals 1 (i.e., non-severe).

Applying the foregoin modules for purposes of this example, it is assumed that computer 110 has already calculated each connection weight for each connection between each system. In this case, connection 350A has a connection weight of 0.2; connection 350B has a connection weight of 0.7; connection 350C has a connection weight of 0.5; connection 350D has a connection weight of 0.9; connection 350E has a connection weight of 0.8; and connection 350F has a connection weight of 0.6. Furthermore, as noted above there are five possible paths from target system 310 to victim system 340 using the various connections 350A through 350F. In particular, path 1 goes from target system 310 to victim system 320 to victim system 340; path 2 goes from target system 310 to victim system 330 to victim system 340; path 3 goes from taget system 310 to victim system 340; path 4 goes from target system 310 to victim system 330 to victim system 320 to victim system 340; and path 5 goes from target system 310 to victim system 320 to victim system 340 to victim system 340. The PW (path weight) for each path is calculated by multiplying each connection weight along the path. For example, the PW of Path 1 is 0.48, which is the connection weight 0.8 of connection 350E times the connection weight 0.6 of connection 350F. Moreover, the PW for path 2 is 0.14, the PW for path 3 is 0.5, the PW for path 4 is 0.108, and the PW for path 5 is 0.54.

Based on these values, the maximum path weigth can be determined. In this example, the MPW[1] between target system 310 and victim system 340 is 0.54; the MPW[2], which is the maximum value for all possible pathways between target system 310 and victim system 320 is 0.8; and the MPW[3], which is the maximum value for all possible pathways between target system 310 and victim system 330 is 0.72. Thus, it should be appreciated according to this example that the easiest access path from a target system to a victim system is not necessarily the direct connection. This concept is critical for determining how to assess threat levels and identify which threat should be address by a remediation action and the priority of doing so. Thus, according to this example, the RPI for target system 310 is approximately 22.5 or greater which is (10/2)*(4+1*0.54+some data about victim systems 320 and 330).

According to the exemplary, this analysis is performed for a plurality of target systems in the distributed system. For example, the computer 110 of FIG. 1 can perform this analysis for each of enterprise clients 132A, 132B and 132C. Then, based on the highest RPI value for each target system, the computer 110 can select an appropriate remediation action to fix the specific vulnerability or other security issue accordingly. Specifically, using the calculated remediation priority index, the prioritization module 250 is configured to determine the target system or application with the most critical vulnerabilities. In another words, the prioritization module 250 determines that the target system/application with the highest remediation priority index should be addressed first. In this aspect, the remediation module 260 is configured to take the appropriate action for the system, which can include a set of instructions, e.g., a script, for performing remedial actions. The remedial actions can include, for example, repairing the computer node (e.g., reversing effects of execution of the malicious file); removing or quarantining a malicious file; closing the vulnerability by installing the appropriate patches; changing infected files (removing the added section of the malicious file, if necessary with the modification of control transfer instructions in this section); decrypting encrypted files, finding and removing rootkits; changing the OS registry branches; removing services registered by the malware; blocking access to certain network addresses; and the like.

Based on the foregoing, the computer 110, through each module, is configured to store a table in the electronic storage 116 about each system and/or application in the system, e.g., involved for the enterprise application, including the following information: system name, system severity, system health, number of directly connected systems, number of potentially accessible systems, number of critical remotely exploitable vulnerabilities in the system, number of default user accounts in the system, number of missing patches in the system, number of code issues in the system, number of access control issues in the system, number of critical events in the system and the calculated remediation priority index.

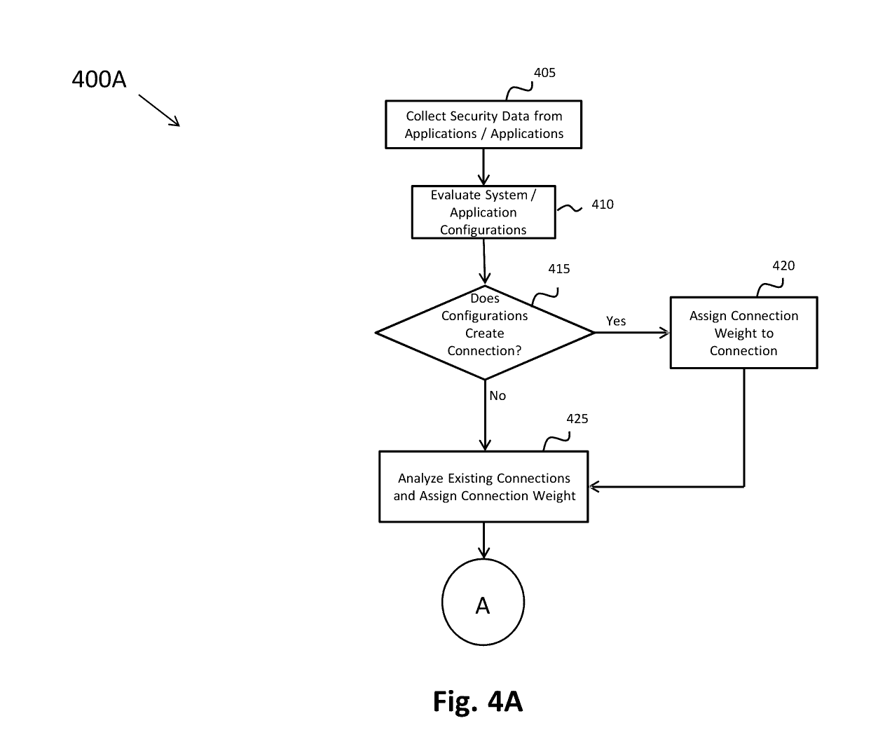

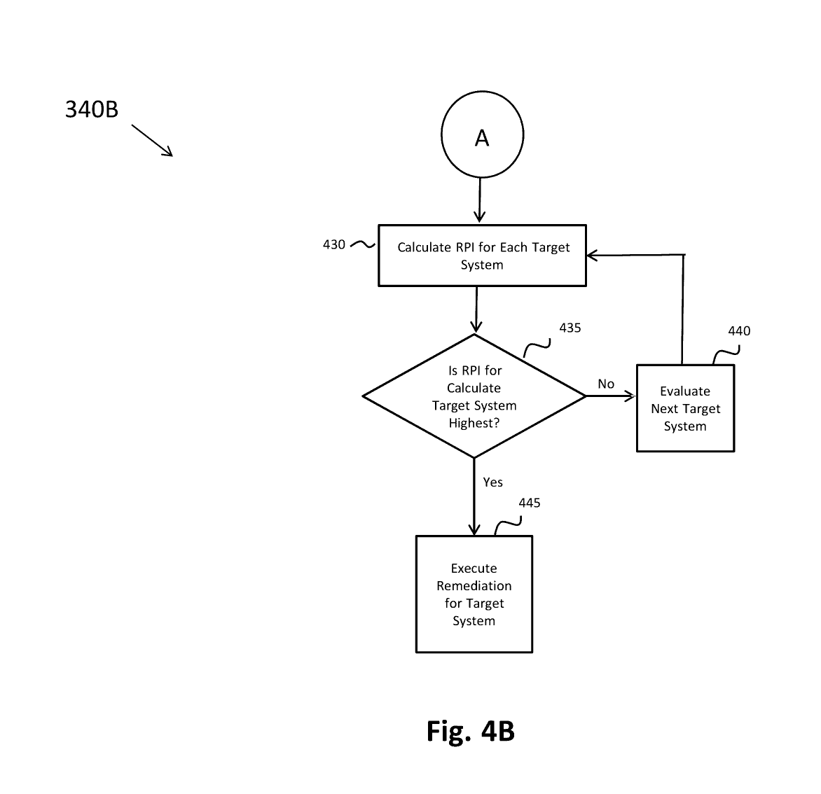

FIGS. 4A and 4B illustrate a flowchart for a method for threat visualization and risk correlation of connected software applications according to an exemplary aspect. Initially, at step 405, the application issue collection module 210 collect information about vulnerabilities of the applications in the target systems, security-related events, or any other security-related problems/issues. Next, at step 410, the connection determination module 220 collects information about different system configurations that allow two systems to trust each other. In particular, the module 220 determines whether the specific system/application configuration creates a “potential” connection between two or more systems/applications that trust each (step 415). If so, the connection determination module 220 determines connection weights for each connection at step 420 according to one or more of the exemplary algorithms described above. If not, the method proceeds directly to step 425.

In either case, the next step is step 425 of the method, although it should be appreciated that step 425 can be performed before steps 415 and 420 according to an alternative aspect. At step 425, the connection evaluation module 230 gather information about all existing connections that enable to systems/applications to access on another and assigns connection weights for each connection accordingly. In this instance, the connection weights indicate the accessibility of each target system for each victim system.

Next, at step 430, the prioritization module 250 calculates the RPI for the target system. Then at step 435, the prioritization module 250 determines whether the target system has the highest RPI among evaluated target systems. If so, the method proceeds to step 445 and identifies and executes the appropriate remediation action to remedy the threat of the target system. If not, the method proceeds to step 440 in which the next target system is evaluated and the method returns to step 430.

Finally, as noted above, comuting system 110 includes a GUI 119 that can provide a graphical representation of the threat modeling of the evaluated computing system. In particular, as a result of threat modelling, the computing system 110 can provide a graphical representation of potential attack paths between systems, for example, as shown in FIG. 3. The connection between one system (a target system) and another (a victim system) means that there is a way to gain access to victim system exploiting a vulnerability in the target system.

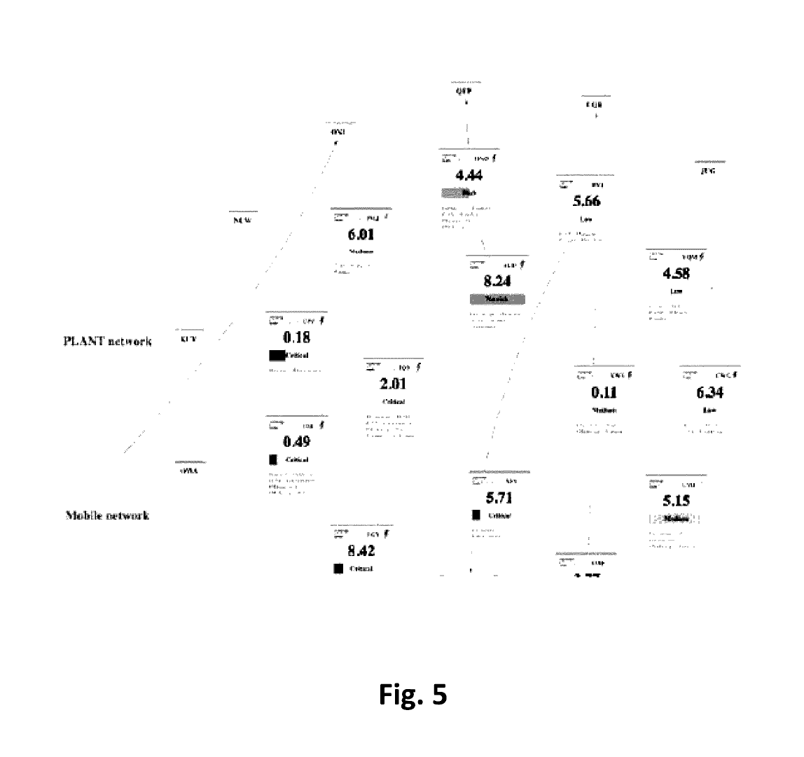

FIG. 5 illustrates a screen shot of a user interface of the graphical representation illustrating a mapping of the systems in the computing environment and their connections according to an exemplary aspect. According to an exemplary aspect, colors of these lines represent a likelihood of this attack. The type line (dotted or not) represent a type of connection, if its real or potential.

As described in detail above, there are two scenarios how vulnerability in one system can affect security of another system. First is a real connection, which is when these two systems are technically connected by using some of the connection interfaces, API's, or other methods. Second is a potential connections when there are no real connections between systems via any interface, but there is a way to exfiltration some data from the target system that can be used to get unauthorized access or simplify exploitation of the victim system. As a simple example, user password can be the same in two systems.

According to an exemplary aspect, the GUI 119 can create a graphical representation by frawing a threat map, in whichi icons for each application (e.g., the target and victim systems) are drawn and connected networks for which the system knows detailed scan information. According to one aspect, different types of applications have specific logos. Examples of mission-critical application types include, but are not limited to, SAP ERP, SAP HANA, SAP Mobile, SAP Solution manager, SAP CUA, SAP GTS, SAP IDM, SAP SAPRouter, SAP GRC, Oracle Peoplesoft, Microsoft Biztalk,Oracle JDE, and the like. Moreover, examples of network types include, but are not limited to, SAP SE Network, SAP Cloud Network, Internet Network, Mobile Devices Network, OT Network, Partner Network and the like

Moreover, the graphical representation includes connections drawn etween the applications. For real connections draw line between connected systems (with an arrow pointing towards one or both applications). For potential connections draw dotted line with arrow pointing towards one or both applications. In one aspect, different colors can be selected for lines (CW=Connection weight). For example, if CW=0, draw a blue line; if CW>0.3, draw an orange line; if CW>=0.5, draw a yellow line; if CW>=0.8, draw a red line; and if CW>=0.95, draw a dark red line.

Moreover, preferably there are actions available for threat map interface. These actions includes moving application icons; selecting to show or hide certain types of connections or certain colors of connections; real connections; potential connections; by clicking on the system show only connections between this system and those which can be hacked from this system; by clicking on “Issues” icon on Application icon show details of found issues for this application such as vulnerabilities, default passwords, and code issues etc.; by clicking on Application icon show details about this application; by clicking on “connections” icon on Application icon show the detailed list of connections between this application and other applications; and filters panel that allow filtering outputs by selecting only those applications or connections with certain risk, amount of issues, criticality and other factors.

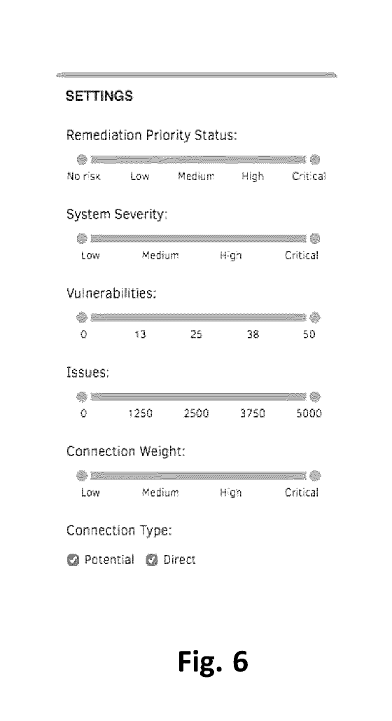

FIG. 6 illustrates a screen shot of a user interface of the graphical representation according to an exemplary aspect. In this aspect, it is possible to filter data which is presented on the map based on different values such as, for example, number of directly connected systems; number of potentially accessible systems; number of different issues (e.g., number of critical remotely exploitable vulnerabilities in the system; number of default user accounts in the system; number of missing patches in the system; number of code issues in the system; number of access control issues in the system; number of critical events in the system); remediation Priority index; system Severity; system health; connection weight and connection type.

Finally, FIG. 7 illustrates an example of a general-purpose computer system (which may be a personal computer or a server) on which the disclosed systems and method can be implemented according to an example aspect. It should be appreciated that the detailed general-purpose computer system can correspond to the computing system 110 described above with respect to FIG. 1. Moreover, the remote computer(s) 49, as described below, can correspond to the enterprise computing system 120 and/or enterprise clients 132A, 132B and 132C, as discussed above with respect to the exemplary system and method.

As shown in FIG. 7, the computer system 20 includes a central processing unit 21, a system memory 22 and a system bus 23 connecting the various system components, including the memory associated with the central processing unit 21. The central processing unit 21 can correspond to the CPU 114 and the system memory 22 can correspond to memory 116 of FIG. 1, according to an exemplary aspect. Furthermore, the system bus 23 is realized like any bus structure known from the prior art, including in turn a bus memory or bus memory controller, a peripheral bus and a local bus, which is able to interact with any other bus architecture. The system memory includes read only memory (ROM) 24 and random-access memory (RAM) 25. The basic input/output system (BIOS) 26 includes the basic procedures ensuring the transfer of information between elements of the personal computer 20, such as those at the time of loading the operating system with the use of the ROM 24.

The personal computer 20, in turn, includes a hard disk 27 for reading and writing of data, a magnetic disk drive 28 for reading and writing on removable magnetic disks 29 and an optical drive 30 for reading and writing on removable optical disks 31, such as CD-ROM, DVD-ROM and other optical information media. The hard disk 27, the magnetic disk drive 28, and the optical drive 30 are connected to the system bus 23 across the hard disk interface 32, the magnetic disk interface 33 and the optical drive interface 34, respectively. The drives and the corresponding computer information media are power-independent modules for storage of computer instructions, data structures, program modules and other data of the personal computer 20.

The present disclosure provides the implementation of a system that uses a hard disk 27, a removable magnetic disk 29 and a removable optical disk 31, but it should be understood that it is possible to employ other types of computer information media 56 which are able to store data in a form readable by a computer (solid state drives, flash memory cards, digital disks, random-access memory (RAM) and so on), which are connected to the system bus 23 via the controller 55.

The computer 20 has a file system 36, where the recorded operating system 35 is kept, and also additional program applications 37, other program modules 38 and program data 39. The user is able to enter commands and information into the personal computer 20 by using input devices (keyboard 40, mouse 42). Other input devices (not shown) can be used: microphone, joystick, game controller, scanner, and so on. Such input devices usually plug into the computer system 20 through a serial port 46, which in turn is connected to the system bus, but they can be connected in other ways, for example, with the aid of a parallel port, a game port or a universal serial bus (USB). A monitor 47 or other type of display device is also connected to the system bus 23 across an interface, such as a video adapter 48. In addition to the monitor 47, the personal computer can be equipped with other peripheral output devices (not shown), such as loudspeakers, a printer, and so on.

The personal computer 20 is able to operate within a network environment, using a network connection to one or more remote computers 49. The remote computer (or computers) 49 are also personal computers or servers having the majority or all of the aforementioned elements in describing the nature of a personal computer 20. Other devices can also be present in the computer network, such as routers, network stations, peer devices or other network nodes.

Network connections can form a local-area computer network (LAN) 50, such as a wired and/or wireless network, and a wide-area computer network (WAN). Such networks are used in corporate computer networks and internal company networks, and they generally have access to the Internet. In LAN or WAN networks, the personal computer 20 is connected to the local-area network 50 across a network adapter or network interface 51. When networks are used, the personal computer 20 can employ a modem 54 or other modules for providing communications with a wide-area computer network such as the Internet. The modem 54, which is an internal or external device, is connected to the system bus 23 by a serial port 46. It should be noted that the network connections are only examples and need not depict the exact configuration of the network, i.e., in reality there are other ways of establishing a connection of one computer to another by technical communication modules, such as Bluetooth.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In the interest of clarity, not all of the routine features of the aspects are disclosed herein. It will be appreciated that in the development of any actual implementation of the present disclosure, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for identifying security threats for software applications in a computing environment and correlating risks of the security threats, the method comprising:
collecting, by a computer processor, information relating to security issues in target systems of the computing environment, the security issues relating to at least one of vulnerabilities of one or more of the software applications being executed on the target systems and one or more security related events occurring on the target systems;
identifying connections of each target system in the computing environment, wherein each connection is between the target system an additional system in the computing environment and the connection enables the target system to access the additional system;
determining a connection weight for each identified connection, the connection weight indicating an ability of the respective target systems to access the additional system using the identified connection;
prioritizing the security threats based on the information relating to the security issues of each target system and the connection weights for each identified connection of each target system; and
selecting at least one remediation action to be performed for at least one security threat based on the prioritizing of the security threats.

2. The method of claim 1, wherein the identifying of connections comprises identifying an existing connection between the target system and the additional system by at least one of a connection interface and an API.

3. The method of claim 2, further comprising:
collecting information associated with the existing connection including at least one of a source system identification, a source host IP address, a destination system identification, a destination source IP address, a connection type, and connection settings; and
determining the connection weight for the existing connection based on the collected information associated with the existing connection.

4. The method of claim 1, wherein the identifying of connections comprises analyzing configurations of the target system that enable access to the additional system in the computing environment by at least one of the software applications.

5. The method of claim 3, wherein the analyzing of configurations of the target system includes identifying at least one of passwords, password hashes, and keys for the target system and determining whether the identified passowrds enable the access to the additional system in the computing environment.

6. The method of claim 1, wherein the prioritizing of the security threats comprises calculating a remediation priority index for each target system in the computing environment.

7. The method of claim 6, wherein the selecting of the at least one remediation action comprises selecting the remediaton action for the target system with the highest remediation priority index.

8. The method of claim 6, wherein the calculating of the remediation priority index is based on system health of the target system, severity of the target system, severity of the additional system, and a maximum value of path weights, wherein each path weight is a product of each connection weight for each direction connection between the target system and the additional system.

9. The method of claim 8, wherein the calculating of the remediation priority index based on the system health of the target system comprises calculating the system health based on a number of type of the security issues.

10. The method of claim 1, wherein the collecting of the information relating to security issues comprises collecting default credentials of the software applications for a list and number of users with default credentials, a list and number of application vulnerabilities, application misconfigurations that enable a hacker to penetrate the target system, a list and number of missing security patches for the software applications, custom source code issues, a list and number of issues in access control of the software applications, and a list and number of security-related events.

11. A system for identifying security threats for software applications in a computing environment and correlating risks of the security threats, the system comprising:
a database comprising a plurality of connection weights associated with a plurality of types of connections between two or more systems in the computing environment; and
a computer processor configured to:
collect information relating to security issues in target systems of the computing environment, the security issues relating to at least one of vulnerabilities of one or more of the software applications being executed on the target systems and one or more security related events occurring on the target systems,
identify connections of each target system in the computing environment, wherein each connection is between the target system an additional system in the computing environment that enables the target system to access the additional system,
determine a connection weight for each identified connection, the connection weight indicating an ability of the respective target systems to access the additional system using the identified connection,
prioritize the security threats based on the information relating to the security issues of each target system and the connection weights for each identified connection of each target system, and
select at least one remediation action to be performed for at least one security threat based on the prioritizing of the security threats.

12. The system of claim 11, wherein the processor is configured to identify the connections by identifying a technical connection between the target system and the additional system by at least one of a connection interface and an API.

13. The system of claim 12, wherein the processor is configured to:
collect information associated with the existing connection including at least one of a source system identification, a source host IP address, a destination system identification, a destination source IP address, a connection type, and connection settings; and
determine the connection weight for the existing connection based on the collected information associated with the existing connection.

14. The system of claim 11, wherein the processor is configured to identify the connections by analyzing configurations of the target system that enable access to the additional system in the computing environment by at least one of the software applications.

15. The system of claim 14, wherein the processor to analyze the configurations of the target system by identifying at least one of passwords, password hashes, and keys for the target system and determining whether the identified passowrds enable the access to the additional system in the computing environment.

16. The system of claim 11, wherein the processor is configured to prioritize the security threats by calculating a remediation priority index for each target system in the computing environment.

17. The system of claim 16, wherein the processor is configured to select the at least one remediation action by selecting the remediaton action for the target system with the highest remediation priority index.

18. The system of claim 16, wherein the processor is configured to calculate the remediation priority index based on system health of the target system, severity of the target system, severity of the additional system, and a maximum value of path weights, wherein each path weight is a product of each connection weight for each direction connection between the target system and the additional system.

19. The system of claim 11, wherein the processor is configured to collect the information relating to security issues by collecting default credentials of the software applications for a list and number of users with default credentials, a list and number of application vulnerabilities, application misconfigurations that enable a hacker to penetrate the target system, a list and number of missing security patches for the software applications, custom source code issues, a list and number of issues in access control of the software applications, and a list and number of security-related events.

20. The system of claim 11, wherein the processor is configured is further configured to display a report of the security threats in the computing environment that includes a map illustrating the identified connections of each target system in the computing environment and configurations for a user to adjust assets of the computing environment, filter data displayed on the map and view details of each target system

21. A non-transitory computer readable medium storing computer executable instructions for identifying security threats for software applications in a computing environment and correlating risks of the security threats, including instructions for:
collecting information relating to security issues in target systems of the computing environment, the security issues relating to at least one of vulnerabilities of one or more of the software applications being executed on the target systems and one or more security related events occurring on the target systems;
identifying connections of each target system in the computing environment, wherein each connection is between the target system an additional system in the computing environment and the connection enables the target system to access the additional system;
determining a connection weight for each identified connection, the connection weight indicating an ability of the respective target systems to access the additional system using the identified connection;
prioritizing the security threats based on the information relating to the security issues of each target system and the connection weights for each identified connection of each target system; and
selecting at least one remediation action to be performed for at least one security threat based on the prioritizing of the security threats.
